(19) United States
(12) Patent Application Publication
(10) Pub. No.: US 2006/0242063 A1
(43) Pub. Date: Oct. 26, 2006

(54) Remote check deposit

(76) Inventors: David L. Peterson, Hahira, GA (US); Ronnie Paul McCulloch, Brentwood, TN (US)

Correspondence Address: Paul E Schaafsma, NovuslP, LLC, Suite 221, 521 West Superior Street, Chicago, IL, 60610-3135, US

(21) Appl. No.: 11/340,537

(22) Filed: Jan. 26, 2006

Related U.S. Application Data
(63) Continuation-in-part of application No. 11/114,254, filed on Apr. 26, 2005.

(51) Int. Cl. G06Q 40/00

(52) U.S. Cl. 705/42; 705/43; 705/45

(57) ABSTRACT

In accordance with the principles of the present invention, a system is provided for capturing a customer deposit at their place of business, converting the Magnetic Ink Character Recognition (MICR) data encoded documents into an image with an associated data file, and electronically transmit the data to a financial institution. The system allows the customer to scan each MICR encoded check that is to be deposited with their financial institution, which captures financial institution routing information and customer account information. The associated image the physical check can be franked denoting the check has been electronically processed to avoid further processing. The resulting image and account data can then be edited and processed by the financial institution. There are three options for encoding the amount: 1) the customer enters each amount after scanning the item prior to sending to the financial institution; 2) the financial institution enters the amount of each item after receiving the file from the customer; and 3) the amount field(s) is scanned and the amount is automatically entered. The system allows for both 1) online (Internet) capture of the MICR data and the associated image or 2) offline capture and the subsequent importing of the image and MICR data for transmission to the financial institution via the Internet. The financial institution can review the items captured online, and repair any item that is incorrect. The financial institution can use the system to print substitute checks that confirm to ANSI X9.90 for processing or deliver an electronic file in ANSI X9.37 format to any check processing system. The system includes secure transport over Internet connections for file transfer and dual control security to reduce fraudulent transactions from being initiated by the customer.

### RELATED APPLICATIONS

This application is a continuation-in-part of U.S. patent application Ser. No. 11/114,254 titled “Remote Check Deposit” filed 26 Apr. 2005.

### FIELD OF THE INVENTION

The present invention relates to remote check deposits.

### BACKGROUND OF THE INVENTION

Every day, business customers deposit thousands of paper checks in financial institutions by physical deposits. Business accounts need to make deposits quickly and conveniently. Rushing to a branch is usually a hassle, even if only blocks away. In addition, because of the delay in depositing paper checks, business owners get feedback on bad checks too late to let them stop shipping an order before it reaches the offending customer.

The Federal Reserve System, often referred to as the Federal Reserve or simply “the Fed”, is the central bank of the United States. It was created on 23 Dec. 1913 by Congress to provide the nation with a safer, more flexible, and more stable monetary and financial system. The Federal Reserve System is basically composed of a central, governmental agency—the Board of Governors—and twelve regional Federal Reserve Banks, located in major cities throughout the nation. The seven members of the Board of Governors are nominated by the President of the United States and confirmed by the U.S. Senate. The current Chairman of the Board of Governors is Alan Greenspan.

In 2000 the Federal Reserve Board staff began investigating a concept of default check truncation rules that is now called the Check Clearing for the 21^{st} Century Act or “Check 21”. The goals of the Check 21 initiative were to enable a financial institution to substitute a machine-readable copy of a check (a “Substitute Check”) for the original check for forward collection or return. These Substitute Checks would be the legal and practical equivalent of the original check.

On 21 Dec. 2001, Chairman Greenspan sent a legislative proposal to the Chairs and Ranking Members of the Senate and House Banking Committees. Both the House and Senate introduced bills in the 107^{th} Congress, and in the 108^{th} Congress the House introduced H.R. 1474 while the Senate introduced S. 1334. On 8 Oct. 2003 the Act passed House of Representatives unopposed. On 14 Oct. 2003, the Act was passed in the Senate by unanimous consent. President Bush signed the bill into law on 28 Oct. 2003. The effective date is 12 months after enactment, which was 28 Oct. 2004.

The Act only covers Substitute Checks. The “Substitute Check” couples the image of the original check with additional routing information. While Check 21 does not address check image formats or the electronic exchange and settlement of “Substitute Checks” rather than paper checks, Check 21 does make such image exchange and settlement possible by giving “Substitute Checks” the legal equivalency of the original checks they represent. Check 21 thus also makes possible a business' ability to remotely and electronically deposit checks with its financial institution.

Remote deposit is a business customer's ability to capture the images and transaction information of checks accepted for payment and the delivery of this information electronically to the financial institution in a format such that the checks can be processed as if the items had been physically received and captured. These electronic items can then be delivered to other financial institutions via an approved file format.

The Act facilitates electronic/image exchanges but electronic/image exchanges are not covered by the Act. The Act encourages the use of electronics by using images of checks to create Substitute Checks that are covered by the Act. The Act does not apply to truncation, safekeeping or image exchange systems which require agreement between the parties, for example, bank image statement services, credit union truncation, check image exchange processes. The Act creates a new legal instrument—the “Substitute Check”—that is the legal equivalent of the original paper check. The Substitute Check: can be processed exactly as if it were the original paper check; cannot be refused by parties wanting to receive paper checks, including other financial institutions, paying customers, depositing customers, consumers, corporations, Federal Reserve, processors, etc.; and is supported by warranties and indemnifications from the financial institution creating the Substitute Check to subsequent parties in collection and return processes.

The Act further creates a new consumer protection feature for those consumers that receive Substitute Checks. Should the consumer experience a loss because they received a Substitute Check that they would not have experienced if they had received the original check, the financial institution has 10 days after a consumer claim to research and credit the consumer's account for check amounts up to $2,500 per check. The availability can be withheld up to 45 days. Regulation CC Availability of Funds and Collections of Checks (12 C.F.R. §229) originally issued by the Federal Reserve Board in September 1988. There are also expedited recredit procedures for financial institutions. There is no special provision for Treasury Checks.

In light of these legislative developments, what is needed is a system by which check truncation can be better facilitated. It would be desirable to foster innovation in the check payment system without mandating physical presentation of checks at a financial institution. It would be further desirable to improve the payment system overall.

### SUMMARY OF THE INVENTION

A system in accordance with the principles of the present invention better facilitates check truncation at the place where checks are first presented. A system in accordance with the principles of the present invention fosters innovation in the check payment system without mandating physical presentation of checks at a financial institution. A system in accordance with the principles of the present invention improves the payment system overall.

In accordance with the principles of the present invention, a system is provided for capturing a customer deposit at their place of business, converting the Magnetic Ink Character Recognition (MICR) data encoded documents into an image with an associated data file, and electronically transmitting the data to a financial institution. The system allows the customer to scan each MICR encoded check that is to be deposited with their financial institution, which captures financial institution routing information and customer account information. The associated image the physical check is franked denoting the check has been electronically processed to avoid further processing. The resulting image and account data can then be edited and processed by the financial institution. There are three options for encoding the amount: 1) the customer enters each amount after scanning the item prior to sending to the financial institution; 2) the financial institution enters the amount of each item after receiving the file from the customer; and 3) the amount field(s) is scanned and the amount is automatically entered. The system allows for both 1) online (web) capture of the MICR data and the associated image or 2) offline capture and the subsequent importing of the image and MICR data for transmission to the financial institution. The financial institution can review the items captured online and repair any item that is incorrect. The financial institution can use the system to print substitute checks that confirm to ANSI X9.90 for processing or deliver an electronic file in ANSI X9.37 format to any check processing system. The system includes secure transport over Internet connections for file transfer and dual control security to reduce fraudulent transactions from being initiated by the customer.

### BRIEF DESCRIPTION OF THE DRAWINGS

FIG. 1 shows a non-limiting example of a hardware infrastructure that can be used to run the system of the present invention.

FIGS. 2a and 2b shows a FI Definition Add screen in accordance with the principles of the present invention.

FIG. 3 shows a FI Configuration screen in accordance with the principles of the present invention.

FIG. 4 shows a FI Deposit Slip Definition Add pop-up screen in accordance with the principles of the present invention.

FIG. 5 shows a FI Add/Edit User Detail screen in accordance with the principles of the present invention.

FIG. 6 shows a Pick-Up Transactions—Remote Deposit screen in accordance with the principles of the present invention.

FIG. 7 shows a Customer Definition Edit screen in accordance with the principles of the present invention.

FIG. 8 shows a Remote Deposit Definition Edit screen in accordance with the principles of the present invention.

FIG. 9 shows a Remote Deposit Category Configuration Edit screen in accordance with the principles of the present invention.

FIG. 10 shows a Customer Administration Menu screen in accordance with the principles of the present invention.

FIG. 11 shows an Opt-Out and Ineligible Items List screen in accordance with the principles of the present invention.

FIG. 12 shows an Opt-Out and Ineligible Items Add screen in accordance with the principles of the present invention.

FIG. 13 shows an Auto Conversion Items List screen in accordance with the principles of the present invention.

FIG. 14 shows an Auto Conversion Add screen in accordance with the principles of the present invention.

FIG. 15 shows an Exception Item Search screen in accordance with the principles of the present invention.

FIG. 16 shows a Transaction Add/Edit screen in accordance with the principles of the present invention.

FIG. 17 shows a FI User Detail screen in accordance with the principles of the present invention.

FIG. 18 shows an FI Administration Menu home page screen in accordance with the principles of the present invention.

FIG. 19 shows a Pickup Transactions—Remote Deposit screen in accordance with the principles of the present invention.

FIG. 20 shows a User Main Menu/Start screen in accordance with the principles of the present invention.

FIG. 21 shows a Remote Deposit Scan screen in accordance with the principles of the present invention.

FIG. 22 shows a Remote Deposit Add/Edit screen in accordance with the principles of the present invention.

FIG. 23 shows an Online Proof screen in accordance with the principles of the present invention.

FIG. 24 shows a Transaction List screen in accordance with the principles of the present invention.

FIG. 25 shows a Transaction Summary screen in accordance with the principles of the present invention.

FIG. 26 shows a Remote Deposit File Load screen in accordance with the principles of the present invention.

FIG. 27 shows an Unauthorize Transactions screen in accordance with the principles of the present invention.

FIG. 28 shows a second Financial Institution Administration Menu home page in accordance with the principles of the present invention.

### DETAILED DESCRIPTION OF THE INVENTION

A system in accordance with the principles of the present invention equips a financial institution's business clientele with the ability to deposit checks remotely without physically depositing checks to a financial institution's branch location. A system in accordance with the principles of the present invention allows checks to be truncated electronically at the business site, deposited online, and picked up by the financial institution as a ‘Check 21 file’. The file may then be processed by any image exchange or check processing system or printed as a substitute check.

In accordance with the principles of the present invention, a business accesses the web using an Internet browser. A check scanner captures the image of the front and back of the check and the associated Magnetic Ink Character Recognition (MICR) data. Alternatively, a standalone scanning system can be used to capture check images and MICR data to create a “Check” file and the resulting file can be delivered for pickup by the financial institution. A customer preferably uses a pure web solution where all access is via an Internet connection and there is no transmission of data or retrieval of data from customer sites. All data entry is performed via web access and all data resides on the web service in a true active server page (ASP) architecture.

In a first embodiment, if the amount field has not been encoded on the item, this amount is manually entered. In a further embodiment, a system in accordance with the principles of the present invention can capture the amount field(s) automatically from the scanned image and enter the amount. Multiple items can be “batched” and submitted for pickup by the financial institution. For customers that have their own scanning capability, the present invention will allow for a “Check 21” file in X9.37 format to be delivered through secure web file delivery.

The present invention allows a Remote Deposit for capturing the check at the place of presentment and converting the image and related MICR data into the X9.37 format. The present invention further allows printing of Image Replacement Documents (IRDs) or Substitute Checks.

The X9.37 format is the current American National Standards Institute (ANSI) standard for electronic exchange of checks and check data among financial institutions and processors. The X9.37 format has been approved by the Federal Reserve Bank for combining check images and related check information into a single file. The Federal Reserve Bank version of the X9.37 file should be supported by all check processing vendors and third-party services.

Although Extended Binary Coded Decimal Interchange Code (EBCDIC) representation is approved by the Federal Reserve Bank and internally created files will be created in the EBCDIC text coding system, the present invention will permit an American Standard Code for Information Interchange (ASCII) text coding system representation to be a Pass Through file with or without validation. At the financial institution, the financial institution will pick up the resulting transactions/file(s) via an online (web) connection which allows individual or collective accumulation of the transaction data into an X9.37 formatted file. The resulting file can be saved to any location within the network of the online (web) access device where the financial institution is performing the file pickup.

The resulting files can be delivered to any internal Local Area Network (LAN)/Wide Area Network (WAN) directory, to be processed by the financial institution's check processing system or service. Since all check vendors will need to process files produced by the Federal Reserve, it is anticipated that every check vendor will offer an update to process the “Check 21” file types approved by the Federal Reserve.

Although the retention of images for access by the banks customers is not required for “Check 21” files, the present invention allows for images to be stored, for example, up to seven (7) years. Access to the images is available via an option on the main menu, via an Internet connection.

In an additional aspect of the present invention, a check is processed in either a Remote Deposit mode or in an accounts receivable conversion (ACH) mode. Based upon the characteristics of a check, a client can designate it for ACH or Remote Deposit when scanned. Three check exception databases are provided. An ARC opt-out database permits a client to comply with National Automated Clearing House Association (NACHA) opt-out rules by automatically routing a designated opt-out account to Remote Deposit and returning an error message in ACH applications. In this additional aspect of the present invention, checks in the opt-out database will be automatically routed to Remote Deposit and return an error message in ARC, Point of Purchase (POP) and Re-Presented Check (RCK) applications. NACHA, 13665 Dulles Technology Drive, Suite 300 Herndon, Va. 20171 is a nonprofit trade association that promulgates rules and operating guidelines for electronic payments. An ineligible database permits a client to enter routing and account information for scanned checks that cannot clear with the MICR information from the check or are returned because of ineligibility, for example, credit card checks. In this additional aspect of the present invention, checks in the ineligible database will be automatically routed to Remote Deposit and return an error message in ARC, Point of Purchase (POP) and Re-Presented Check (RCK) applications.

An auto conversion database permits a customer to automatically convert routing and/or account information when a designated check is scanned to facilitate clearing via automatic clearing house (ACH). As an example, many credit unions and other smaller financial institutions utilize “pay through” services for paper checks but receive ACH transactions directly. Usually, the MICR line from a paper check of a pay through bank will not clear via the ACH network. If the routing number is converted, or if a processing code in the account number is removed, these paper checks can be converted to ACH and cleared via ACH. The ARC Opt-Out database is applicable only to ARC applications. The Ineligible check and Auto Conversion databases are applicable to ARC, POP, and RCK. The ARC Opt-Out, Ineligible, and Auto Conversion database will be checked at scan, and any time the transaction is saved.

In accordance with the present invention, mixing two distinct types of transactions into a single category result in ACH or Remote Deposit specific processing rules that cannot apply across the category. This additional aspect of the present invention comprises a “ghost” category for ARC and a “ghost” category for Remote Deposit. Screens and reports display combined transactions, but processing requirements for each is controlled by existing ARC or Remote Deposit system rules and processes. The present invention can be enabled at the financial institution level. Otherwise, these options do not appear on any financial institution setup screens. Financial institution and customer setup screens can enable a hybrid category (for example: “SmartScan”) via setup options for Remote Deposit.

ACH transactions can be manually reclassified as Remote Deposit, but Remote Deposit transactions can be manually reclassified as ACH only if they can be validated as eligible for ACH. During reclassification, a high dollar check threshold option that routes automatically to Remote Deposit if enabled will be ignored in the ARC validation process so high dollar items can be re-routed via ARC. Reclassification permits a user to consolidate ARC transactions into a Remote Deposit transaction type, for example, to simplify processing on a particular day or if the ARC volume does not justify processing two files and the extra fees associated with a small number of ACH transactions. To permit reclassification, front/back images for ARC designated transactions will required and then maintained in the database (ACH Rules require front only archive for ARC; Check 21 requires front/back as part of X9.37 file). If a Remote Deposit transaction is reclassified ARC when ARC archival is enabled, the image will be retrieved from the database and submitted to archive at save unless Remote Deposit image is enabled and the image was previously sent to archive. Image archive for Remote Deposit transactions reclassified as ARC includes the front of the check.

In an additional feature in accordance with the principles of the present invention, online proof can be provided. Online proof permits the financial institution to restrict the customer's entry of check amounts, thus requiring the financial institution to add check amounts prior to downloading the zero dollar collection that is in ready for financial institution pickup status. Using online proof, the financial institution has the ability to review transactions and images prior to downloading with the capability to edit the customer's collection, including the amount field.

Thus, the present invention provides the financial institution with the options to require the customer to enter check amount and prohibit the customer from entering the check amount. If the customer is prohibited there are two options: the customer scans the check but cannot enter check amount and financial institution user must perform “proof” prior to X.937 file creation and download; or the customer scans check but cannot enter check amount and financial institution is permitted to download a zero dollar X9.37 file that can be used to proof/repair the zero dollar transactions within the financial institution.

While in the embodiment described herein the present invention is operated on the Web-based ACH origination service, Goldleaf Client, available from Goldleaf Technologies, 214 Overlook Ct., Suite 120, Brentwood, Tenn. 37027 USA, the principles of the present invention can be applied to other, alternative systems or as a stand-alone system.

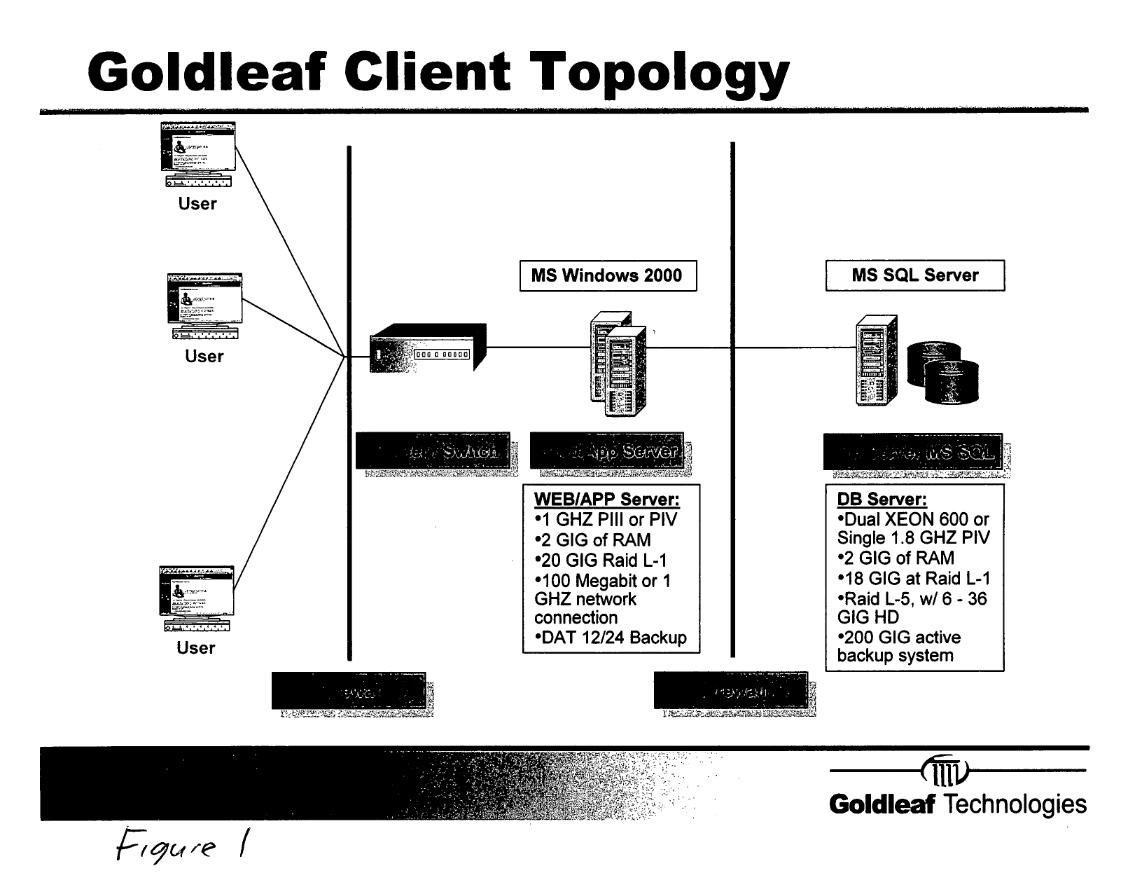

Referring to FIG. 1, a non-limiting example of a hardware infrastructure that can be used to run the system of the present invention is seen. The infrastructure preferably can include but is not limited to: Internet connectivity; network infrastructure; MS Windows NT or 2000 network available from Microsoft Corporation, Redmond, Wash.; firewall(s); Load Balancer (optional if more than one WEB/APP server running the application); appropriate switches and routers; electrical Power (backup power); Network Backup hardware and software, and a check scanner.

The application can run the Secure Sockets Layer (SSL) protocol. The WEB/APP Server can be a 1 GHZ PIII or PIV, or dual processor PIII or PIV at 600 MHZ, with 2 GIG of RAM, 20 GIG Raid level 1, 100 Megabit or 1 GHZ network connection, and DAT 12/24 Backup system. The Database Server can be a Dual Processor XEON 800 or Single Processor 1.8 GHZ PIV with 1 GIG of RAM, ON-Board 18 GIG at Raid level 1, either on-board or external disk array running raid level 3, with 3-36 GIG hard drives, and 100 GIG active backup system, capable of backing up and restoring while the system is active. The system software can be a WEB/APP Server—running Windows 2000, or Windows 2000 Advanced Server for dual processor machine; a Database Server—running Windows 2000 Advanced Server and SQL Enterprise Edition for dual processor machine or an active/passive configuration for redundancy.

Initially, a use parameter can be established at the system creation level utilizing a database encrypted default setting script. This parameter will be to enable or disable Remote Deposit. The default value can be “No”. If the default value at the system creation level is “Yes”, this option can be enabled at the system level. If the value is changed to “Yes” at the system level, the financial institution can enable a Remote Deposit Category and/or Remote Deposit File Load for any Customer (Originator)/branch.

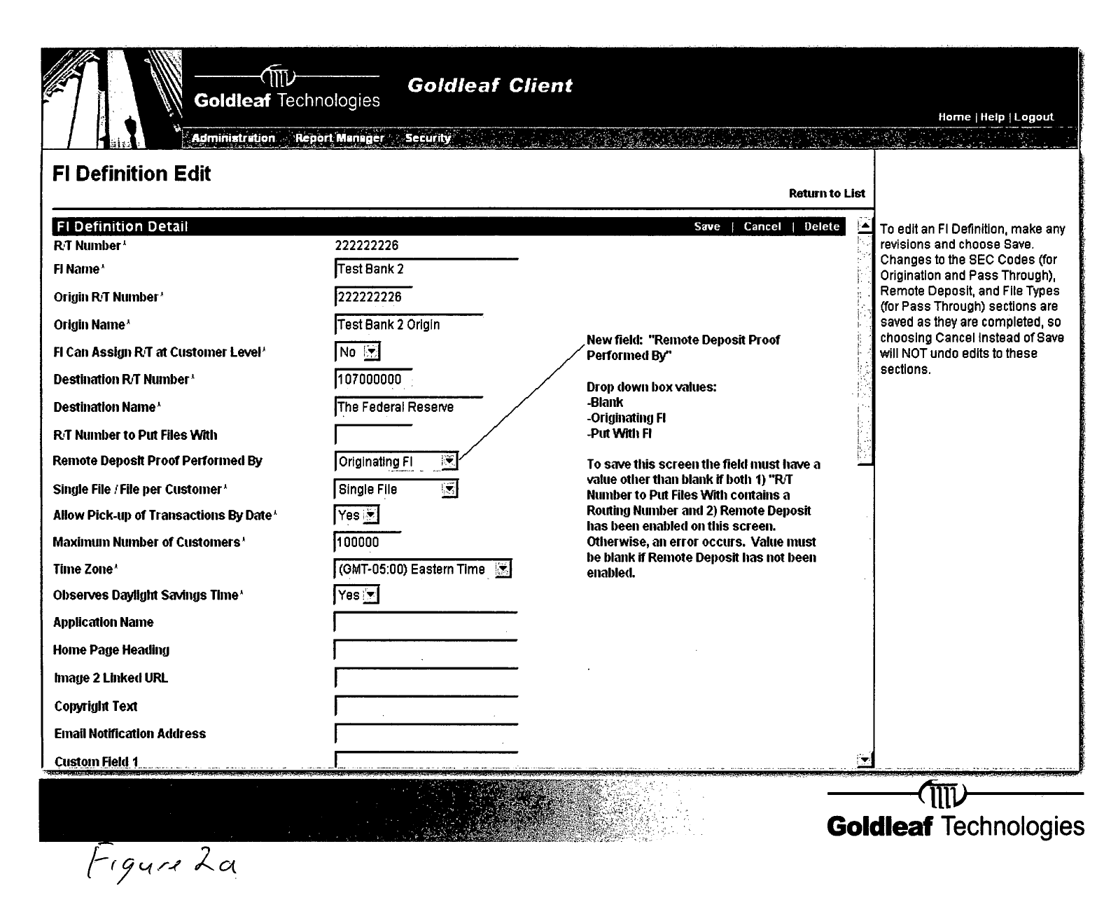

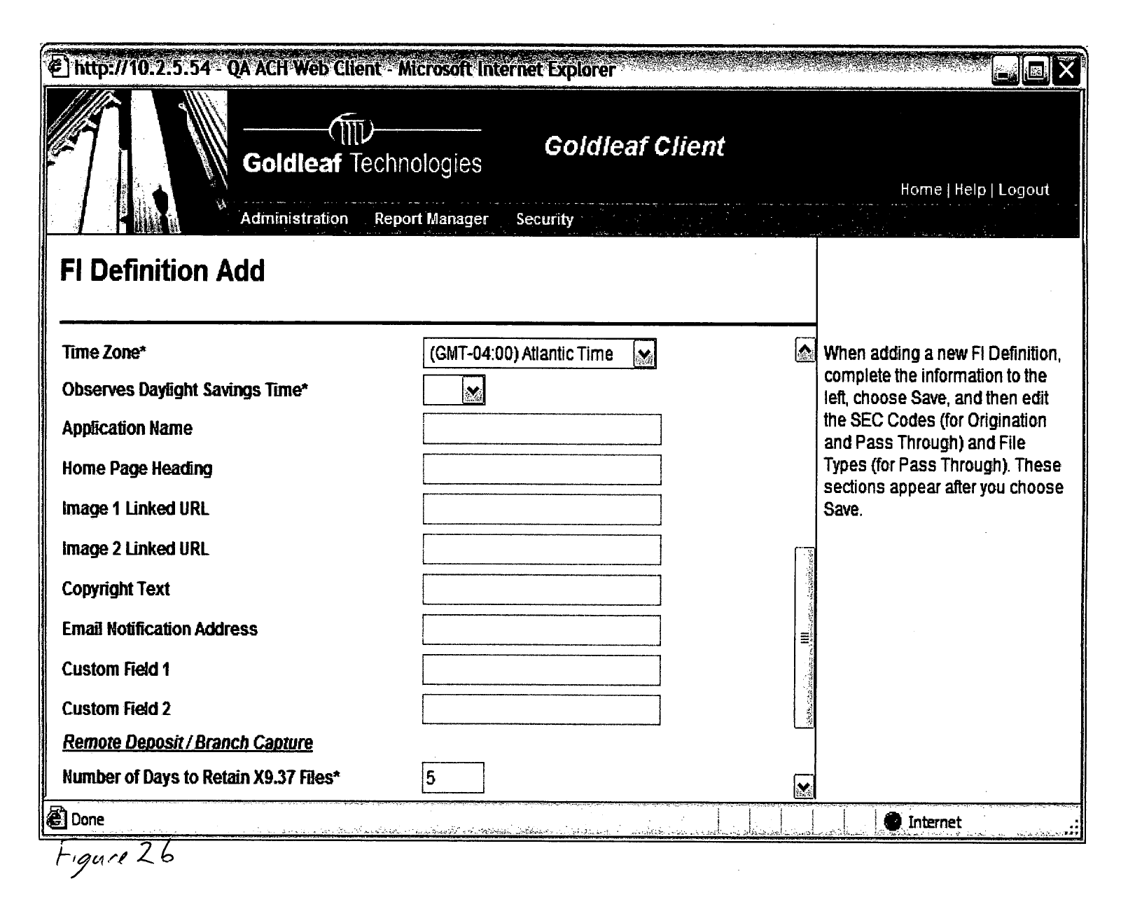

Next, the system level is set up. Referring to FIGS. 2a and 2b, the financial institutions are provided a FI Definition Add screen. The FI Definition Add screen can include as fields R/T Number, FI Name, Origin R/T Number, Origin Name, FI Can Assign R/T at Customer Level, Destination R/T Number, Destination Name, R/T Number to Put Files With, Remote Deposit Proof Performed By, Single File/File per Customer, Allow Pick-up of Transactions by Date, Maximum Number of Customers, Time Zone, Application Name, Home Page Heading, Image 2 Linked URL, Copyright Text, e-Mail Notification Address, Custom Fields, and Number Of Days To Retain X9.37 Files for the financial institution to fill in.

The Remote Deposit Proof Performed By includes a drop down menu with Blank, Originating FI or Put With FI, with a default blank value. Remote Deposit Proof Performed By instructs the system to send collections to the originating financial institution or the Put With financial institution. The Remote Deposit Proof Performed By field must be set to originating financial institution for the originating financial institution to access the proof function; otherwise, collections go directly to the Put With R/T established at the system level. If the originating financial institution is selected, the originating financial institution must approve all Remote Deposit collections before they move to the Put With financial institution. The normal workflow would be to perform proof or just review a collection, save or cancel and approve the collection's move to the Put With financial institution. If the Put With field contains a value and Remote Deposit is enabled on the FI Definition screen, the screen cannot be saved unless it contains a value of Originating FI or Put With FI in this field. The value must be blank to save if Remote Deposit has not been enabled on the screen.

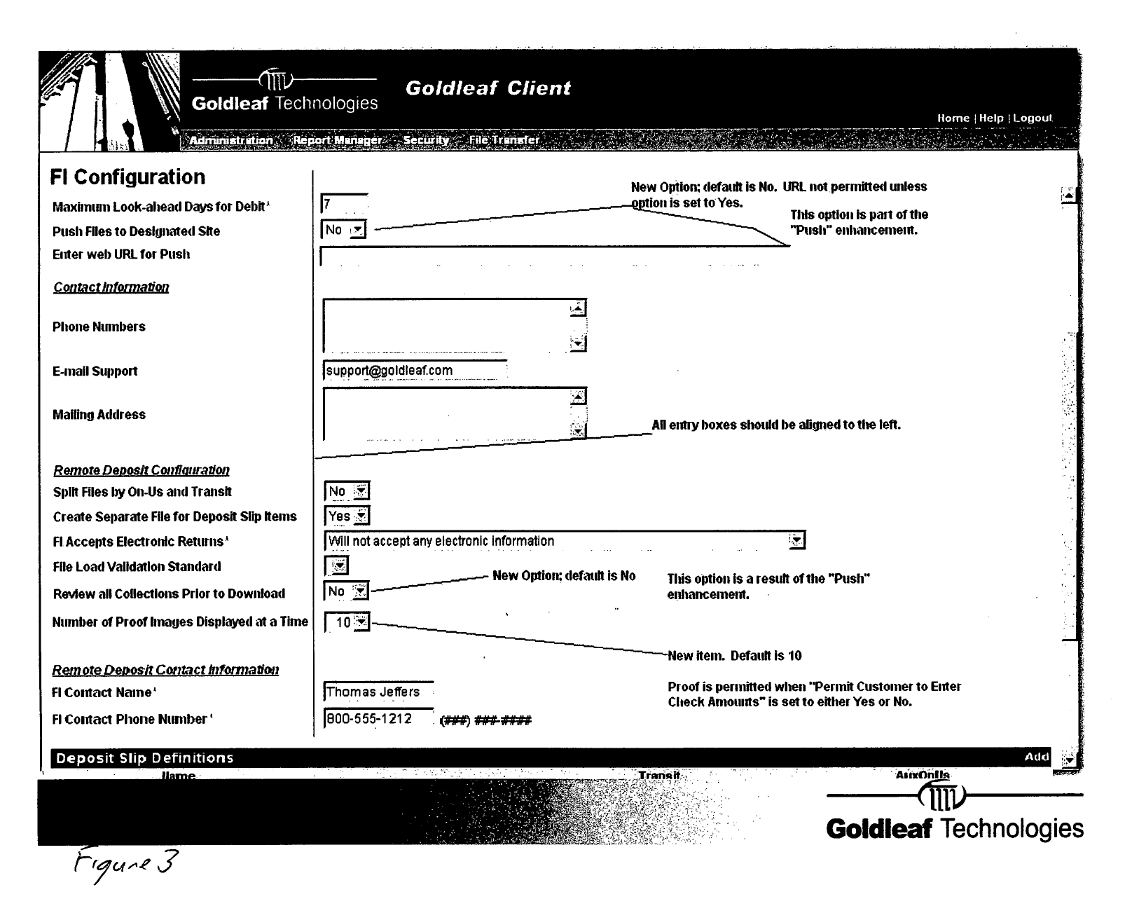

Referring to FIG. 3, a FI Configuration screen is seen. Administration, Report Manager, Security, and File Transfer drop-down menus can be provided. By selecting Administration, the drop-down menu appears. By selecting FI Definition, a drop down menu appears. By selecting FI (or Add FI per existing procedures), an FI Definition Edit screen (or Add as appropriate) appears. In the FI Definition Edit screen at the Remote Deposit section Select Add can be selected. To enable the additional aspect of the present invention in which a check is processed in either a Remote Deposit mode or in an accounts receivable conversion mode, at the Remote Deposit File Type screen, SmartScan can be selected by marking the adjacent box.

The FI Configuration screen includes as fields a Maximum Look-Ahead Days for Debt, Push Files to Designated Site, and Enter web URL for Push. A Remote Deposit Configuration section is provided. The financial institution enters the information that will control the way the application will manage the plitting of X9.37 files into separate logical files representing deposit slips, on-us transactions and transit (non On-Us) transactions, and the method of handling electronic returns. The Remote Deposit Configuration section can include as fields Split Files by On-Us and Transit, Create Separate File for Deposit Slip Items, FI Accepts Electronic Returns, File Load Validation Standard, Review all Collections Prior to Download, and Number of Proof Images Displayed at a Time. A Contact Information section can includes as fields Phone Numbers, e-Mail support, and Mailing Address fields. The FI Configuration screen further can include as fields a Remote Deposit Contact Information section having FI Contact Name and FI Contact Phone Number. A Deposit Slip Definitions and Links fields are provided. Selecting ‘Add’ in the Deposit Slip Definition filed links to a FI Deposit Slip Definition Add pop-up screen.

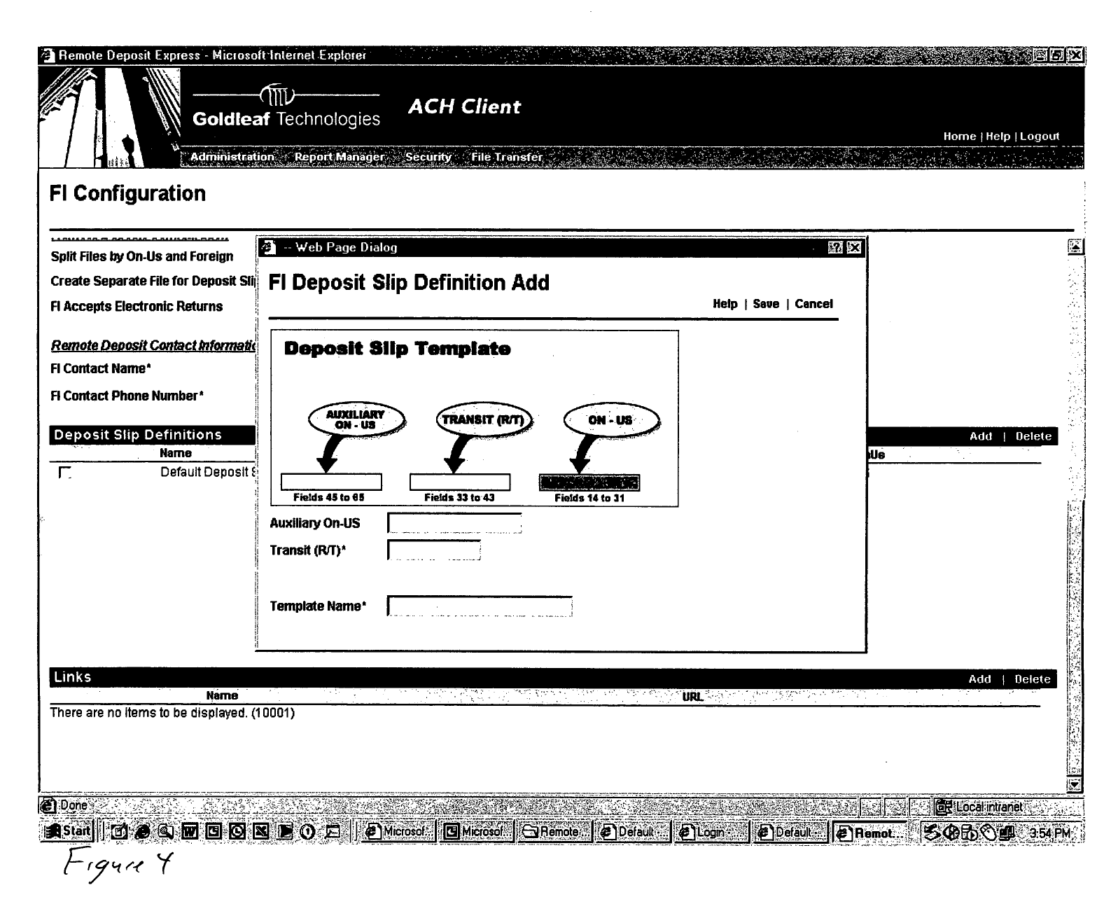

Next, referring to FIG. 4, a FI Deposit Slip Definition Add pop-up screen is seen. One or more Deposit Slip definitions are created. Deposit Slip definitions allow for virtual representations of the physical deposit slips used by financial institutions with their customers. A Deposit Slip Template section can include as fields Auxiliary On-Us and Transit (R/T). A Template Name field can also be provided.

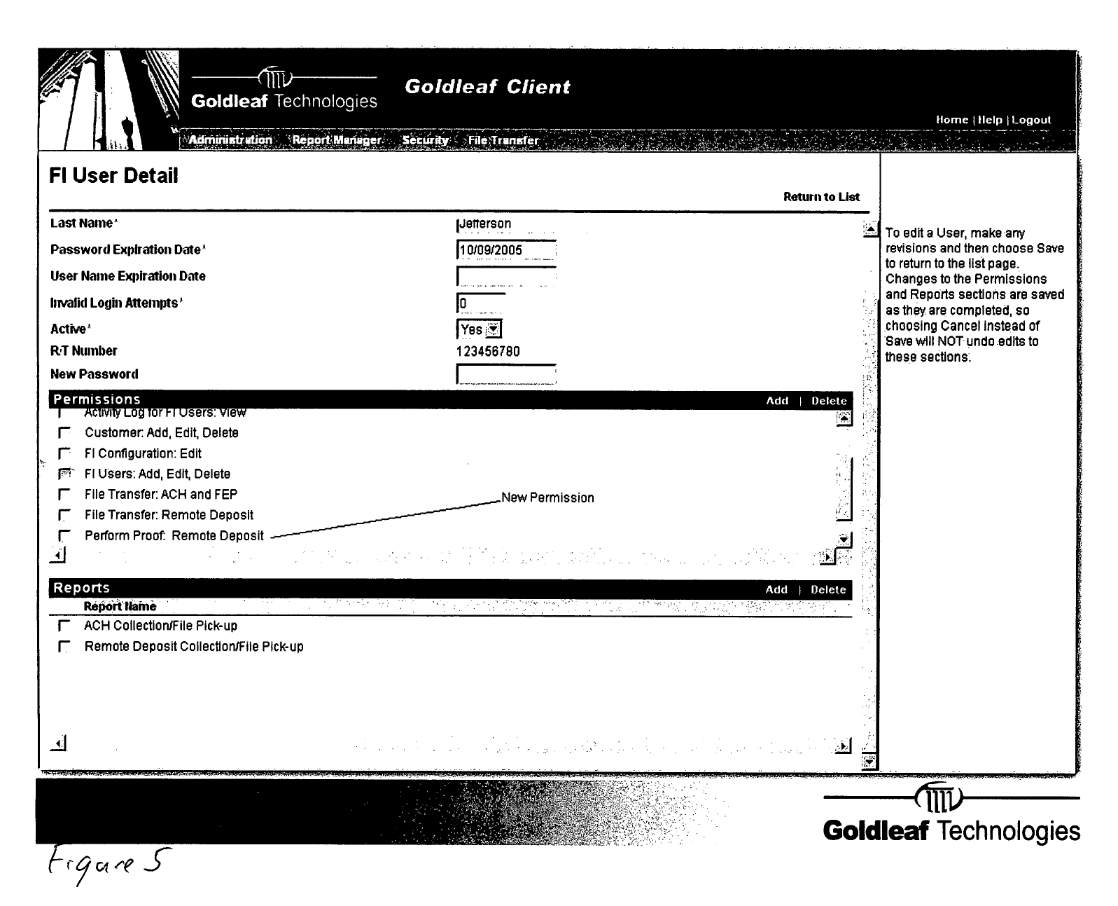

Referring to FIG. 5, a FI User Detail screen is seen. Administration, Report Manager, Security, and File Transfer drop-down menus can be provided. The FI User Detail screen can include as fields Last Name, Password Expiration Date, User Name Expiration Date, Invalid Login Attempts, Active drop down menu (yes or no), R/T Number, and New Passwords. A Permissions section is provided having as fields, for example, Activity Log for FI Users View; Customer: ADD, Edit, Delete; FI Configuration: Edit; FI Users: Add, Edit, Delete; File Transfer: Remote Deposit; Perform Proof: Remote Deposit; etc. A Reports section can include as fields ACH Collection/File Pick-up and Remote Deposit Collection/File Pick-up. In the Perform Proof: Remote Deposit field, permission must be enabled for financial institution user to perform proof functions

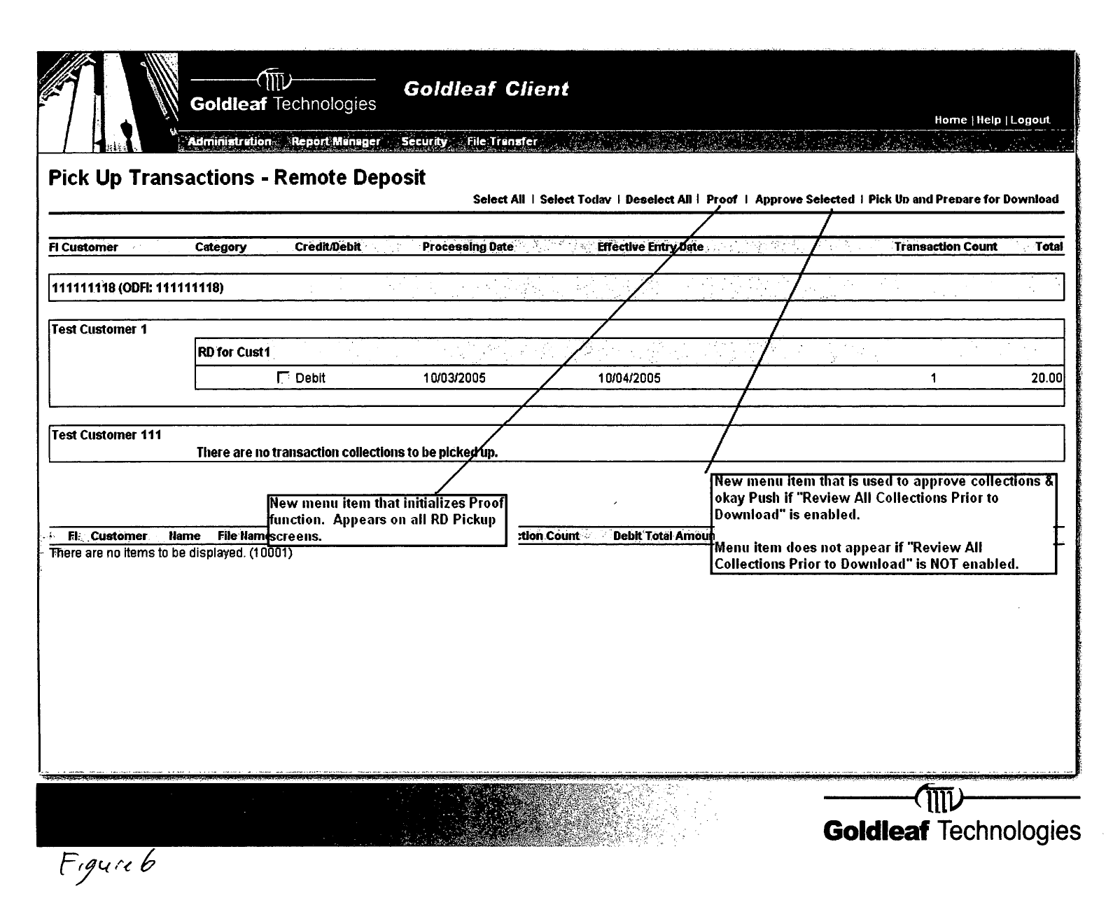

Referring to FIG. 6, a Pick-Up Transaction—Remote Deposit screen is seen. Administration, Report Manager, Security, and File Transfer drop-down menus can be provided. Select All, Select Today, Deselect All, Proof, Approve Selected, and Pick Up and Prepare for Download function keys can be provided. At Pick Up and Prepare for Download, transactions will be placed into an ACH or X9.37 file as appropriate according to the routing designator value. The Pick-Up Transaction—Remote Deposit screen can include as columns FI Customer, Category, Credit/Debit, Processing Date, Effective Entry Date, Transaction Count, and Total. The rows list customers with collections available for pickup. The Proof field displays when the user has proof authority; otherwise, it is hidden. When the financial institution user has proof authority, collections requiring proof will display and proof function can occur for the selected collection. The Approve Selected field is used to approve push collections and initiates the push functionality when “Review All Collections Prior to Download” is enabled. The Approve Selected field does not appear if “Review All Collections Prior to Download” is not enabled; if push is not enabled, but a Put With R/T has been designated in the system FI Definition screen and the value of the “Proof Performed By” field is set to Originating FI, the Approve Selected field approves proof collections. If neither of these functions has been enabled, the Approve Selected field does not appear.

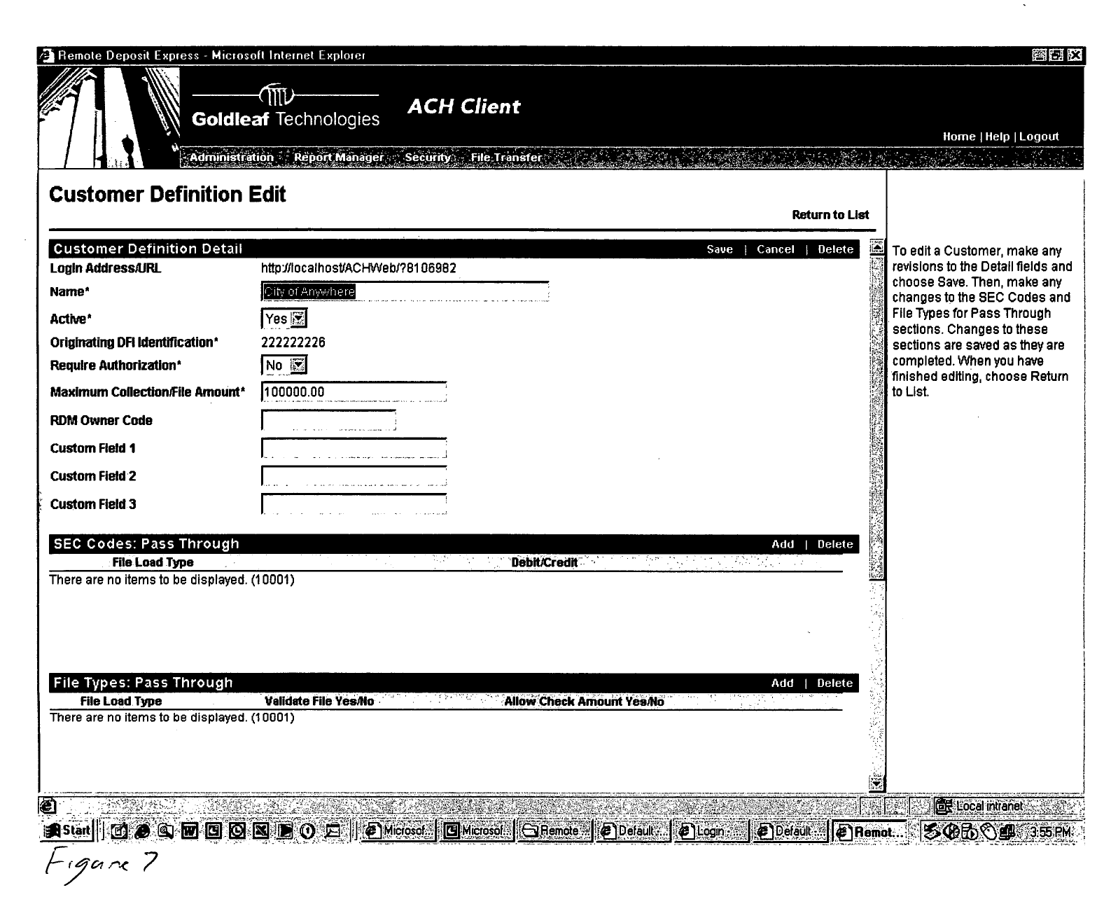

Next, referring to FIG. 7, a Customer Definition Edit screen is seen. The customer specific information is entered to allow a customer access to the application. The Customer Definition Edit screen can include as fields a Customer Definition Detail section having Login Address URL, Name, Active, Originating DFI Identification, Require Authorization, Maximum Collection/File Amount, RDM Owner Code and Custom Fields. The Customer Definition Edit screen further can include as fields SEC Codes: Pass Through and File Types: Pass Through.

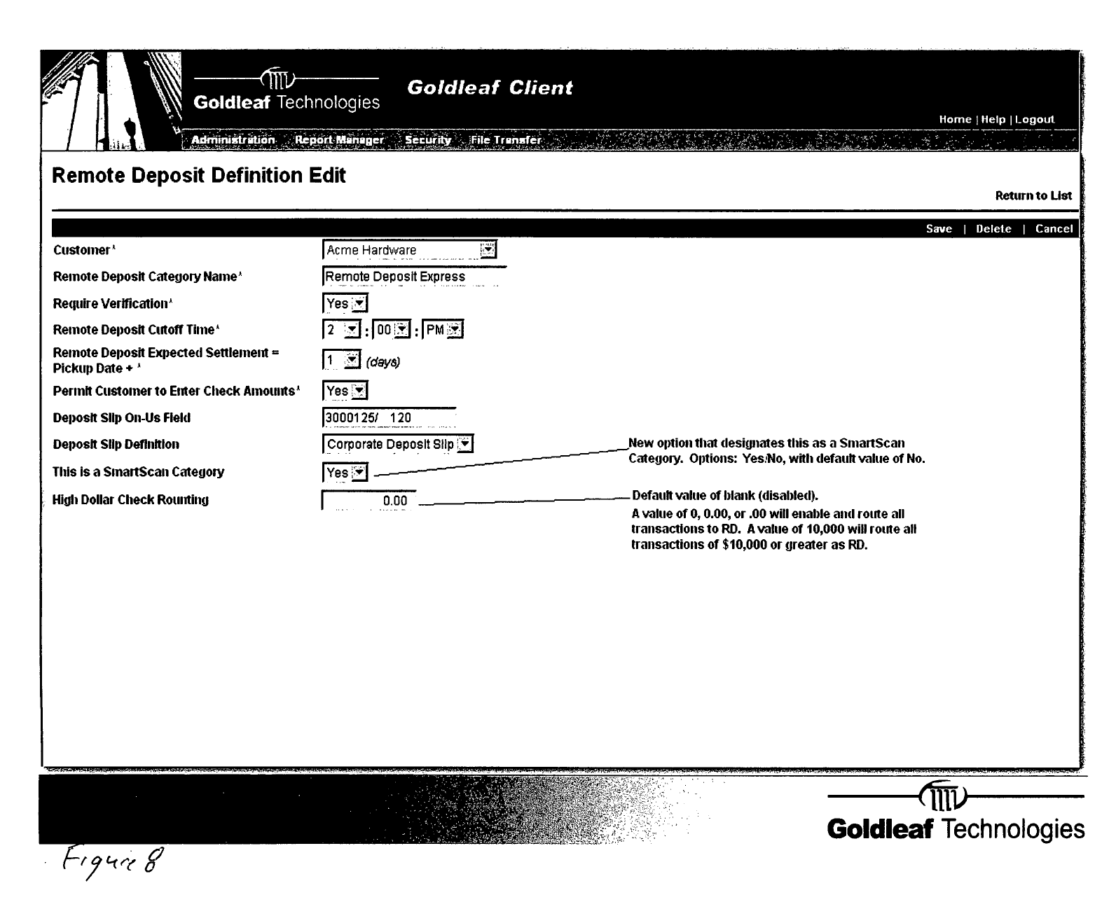

Referring to FIG. 8, a Remote Deposit Definition Edit screen is seen. The Remote Deposit Definition Edit screen allows the financial institution to customize the Remote Deposit application for each customer allowed to access the system. The Remote Deposit Definition Edit screen can include as fields Customer, Remote Deposit Category Name, Require Verification, Remote Deposit Cutoff Time, Remote Deposit Expected Settlement=Pickup Date+, Deposit Slip On-Us Field, Deposit Slip Definition, “This is a Smartscan Category”, and High Dollar Check Routing. Remote Deposit Cutoff Time can be added as a drop down box to include hours (i.e. 1-12), minutes (00-60), and (AM/PM). The Remote Deposit Expected Settlement equals the financial institution Pickup Date plus a drop down box including for example days 0-20. If file is picked up by a financial institution after the financial institution's system specified cutoff time, for settlement calculation purposes, the base date can be moved to the next business day.

The Smartscan Category contains a drop-down box to designate as a Smartscan category, having a default of “No”. To enable the additional aspect of the present invention in which a check is processed in either a Remote Deposit mode or in an accounts receivable conversion mode, “Yes” is selected. A value in High Dollar Check Routing cannot be saved unless “This is a SmartScan Category” has a value of Yes or is saved with a value of Yes. High Dollar Check Routing has a default value of blank—disabled. A value of 0, 0.00 or 0.00 will enable and route all transactions to Remote Deposit. A value of 10,000 will route all transactions of $10,000 or greater as a Remote Deposit. Transactions below the High Dollar Check Routing threshold or when the field is disabled are routing to ARC or Remote Deposit as appropriate without consideration of a threshold.

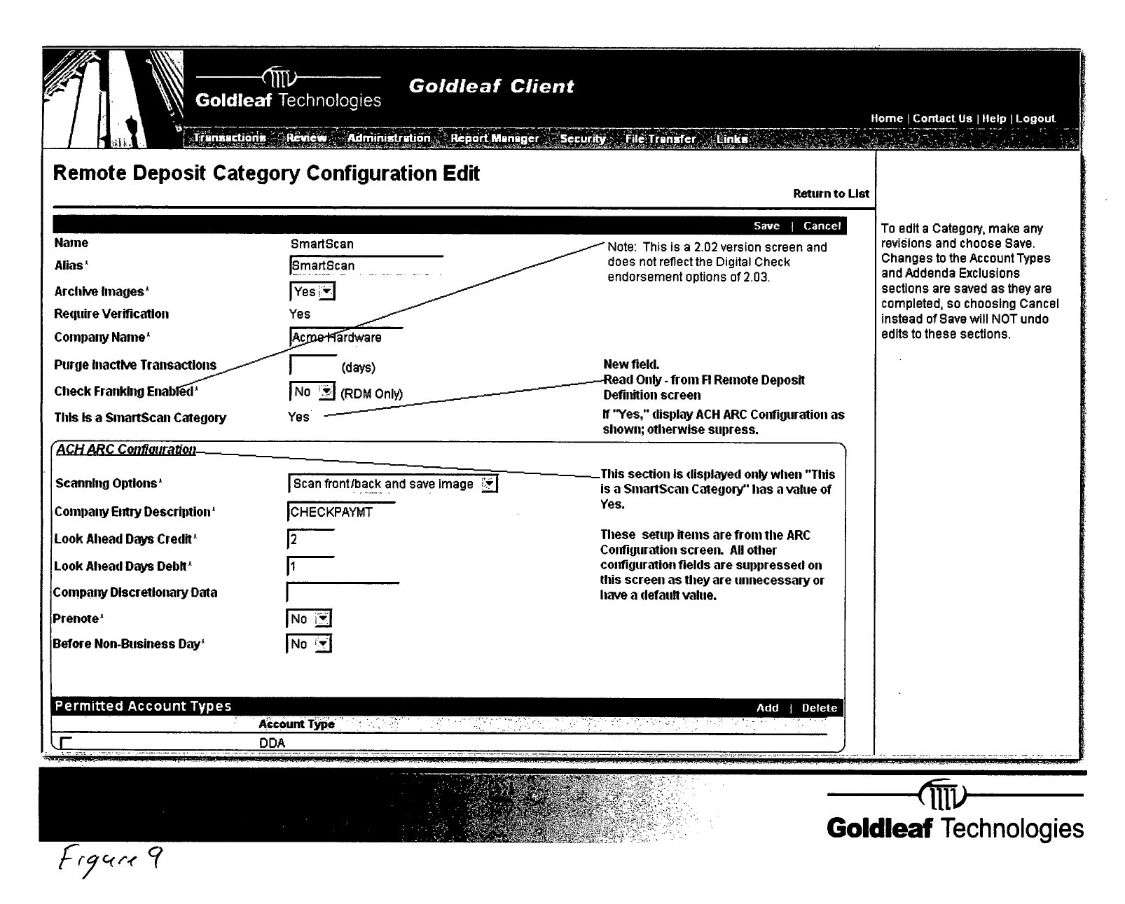

Referring to FIG. 9, a Remote Deposit Category Configuration Edit screen is seen. The Remote Deposit Category Configuration Edit screen includes as fields Name, Alias, Archive Images, Requires Verification, Company Name, Purge Inactive Transactions, Check Franking Enabled, and This is a Smartscan Category. The “This is a Smartscan Category” designation is set at the Remote Deposit Definition Edit screen seen in FIG. 8. When the “This is a Smartscan Category” is designated as “Yes”, an ACH ARC Configuration Section is displayed. The ACH ARC Configuration Section has as fields Scanning Options, Company Entry Description, Look Ahead Days Credit, Look Ahead Days Debit, Company Discretionary Data, Prenote, and Before Non-Business Day. The Scanning Options is a drop down menu that includes as options Scan Front/Back and Save Image and Scan Front/Back and Do Not Save Image. Several fields that are required for ARC configuration that do not appear on this screen include SEC Code (set to ARC), Credit/Debit/Both (set to Debit), Allow Check Scanning (set to “Yes”) and Addenda Exclusions (not applicable for ARC or Remote Deposit).

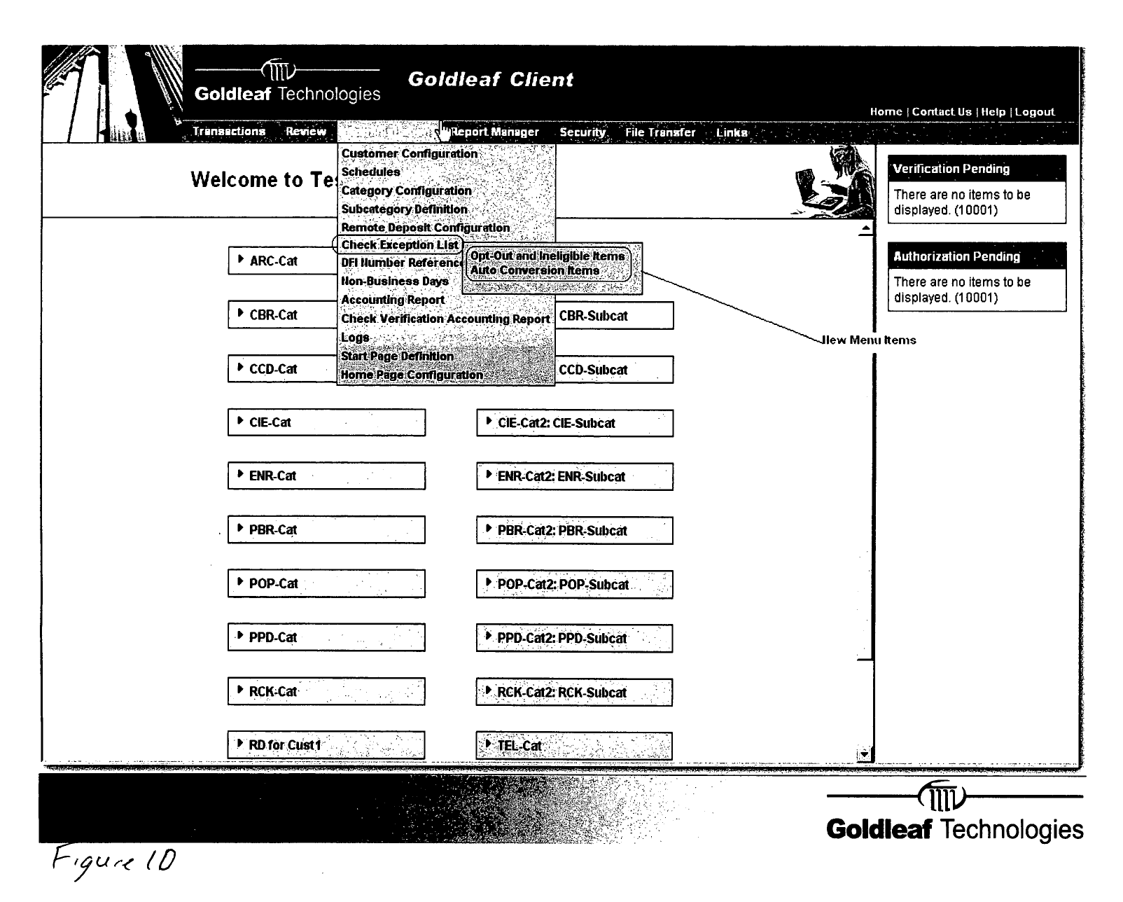

Referring to FIG. 10, a Main screen is seen. The main screen includes Transactions, Review, Administration, Report Manager, Security, File Transfer, and Links as drop-down menus. Administration categories include Customer Configuration, Schedules, Category Configuration, Remote Deposit Configuration, Check Exception List, DFI Numbers References, Non-Business Days, Accounting Report, Check Verification Accounting Report, Logs, Start Page Definition, and Home Page Configuration. The Check Exceptions List appears only if the financial institution has enabled an ARC, Point of Purchase (POP) or Re-Presented Check (RCK) category. If Check Exception List appears on the Administration menu, Opt-Out and Ineligible Items Auto Conversion Items tertiary menus appear. Selecting one of these menus navigates the user to the appropriate list.

To configure the additional aspect of the present invention in which a check is processed in either a Remote Deposit mode or in an ACH ARC mode, Administration is selected. Remote Deposit Configuration is selected from the Administration drop down menu. The Remote Deposit Category to be used is selected. The listed items are completed. If this additional aspect of the present invention has been enabled for this category, the ACH ARC Configuration items will be displayed. Setup items have same values and mandatory/non-mandatory labels as the straight Remote Deposit and ARC category configuration settings. If this additional aspect of the present invention has not been enabled for this category, features for this additional aspect of the present invention will not be displayed to the user. After save, the category is configured, and the user is ready to select begin scanning checks from the Transaction List.

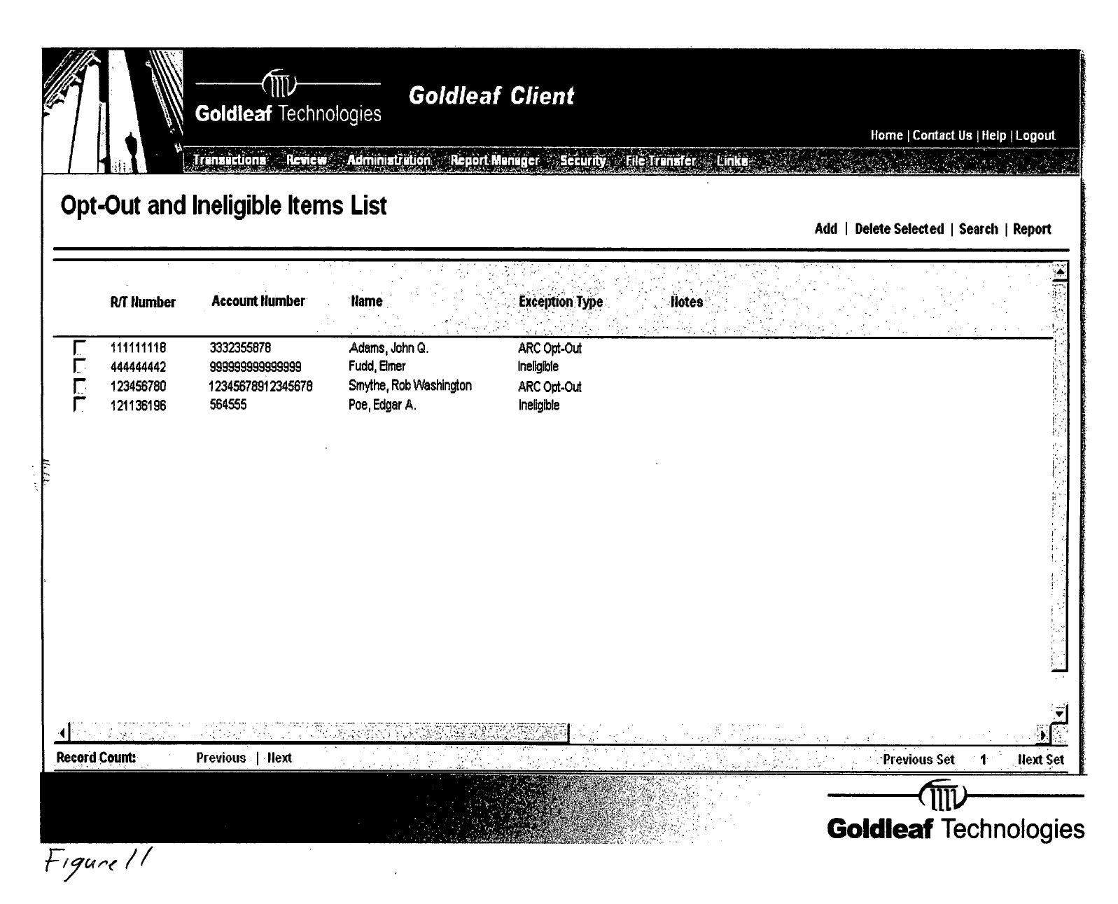

Referring to FIG. 11, an Opt-Out and Ineligible Items List screen is seen. Add, Delete Selected, Search, and Report function keys can be provided. The Opt-Out and Ineligible Items List screen includes as columns R/T Number, Account Number, Name (optional), Exception Type, and Notes (optional). Exception type can be ARC Opt-Out or Ineligible and can be populated from the Remote Deposit Definition Edit screen of FIG. 8. Selecting Add takes the user to the exception item creation Add screen. Selecting “Delete Selected” removes the exception item(s) that were checked on the list. Selecting Search takes the user to the exception item search page. The search page contains all columns from this page. Selecting Report creates an Opt-Out and Ineligible Items List report and sends it to the Report Manager.

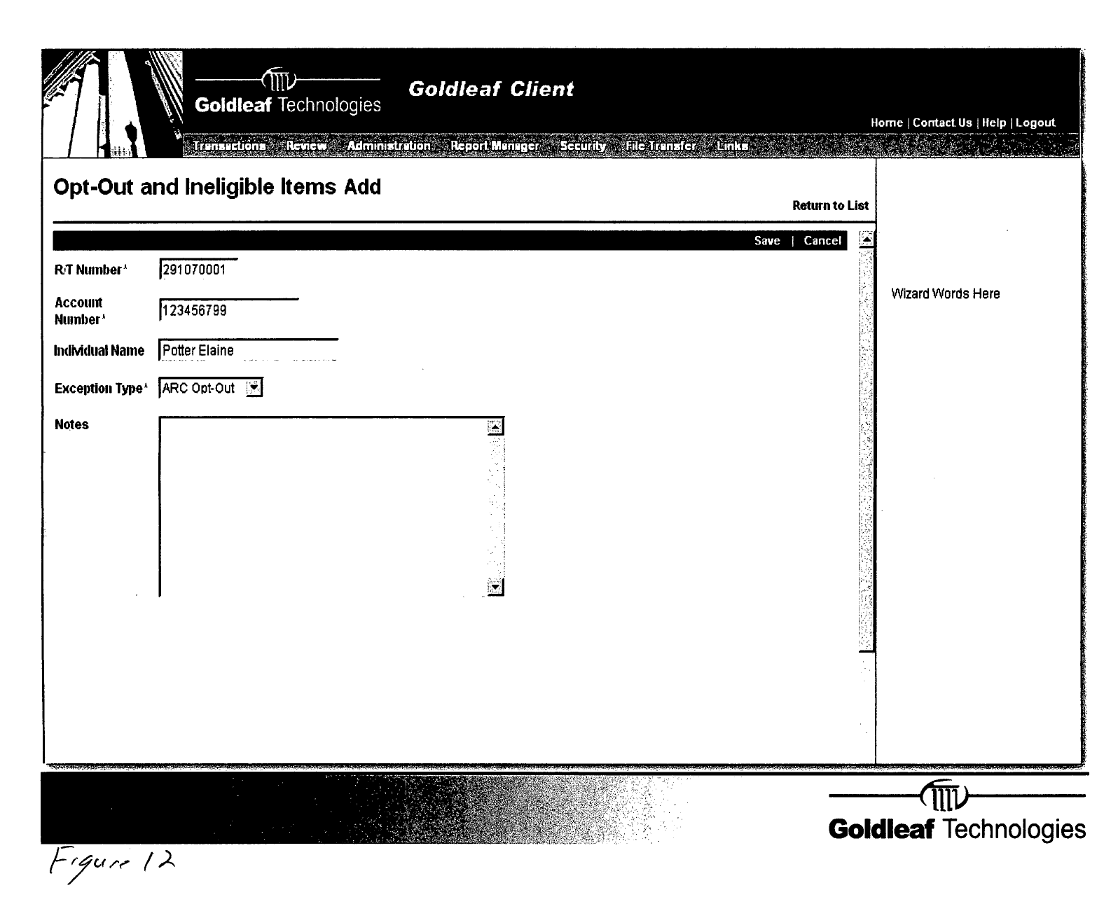

Referring to FIG. 12, an Opt-Out and Ineligible Items Add/Edit screen is seen. The Opt-Out and Ineligible Items Add screen includes as fields R/T Number, Account Number, Individual Name (optional), Exception Type, and Notes (optional). Exception Type is a drop down menu with ARC Opt-Out or Ineligible options, with a default set to blank. If the financial institution prohibits customer from entering the check amount, the amount field will be hidden.

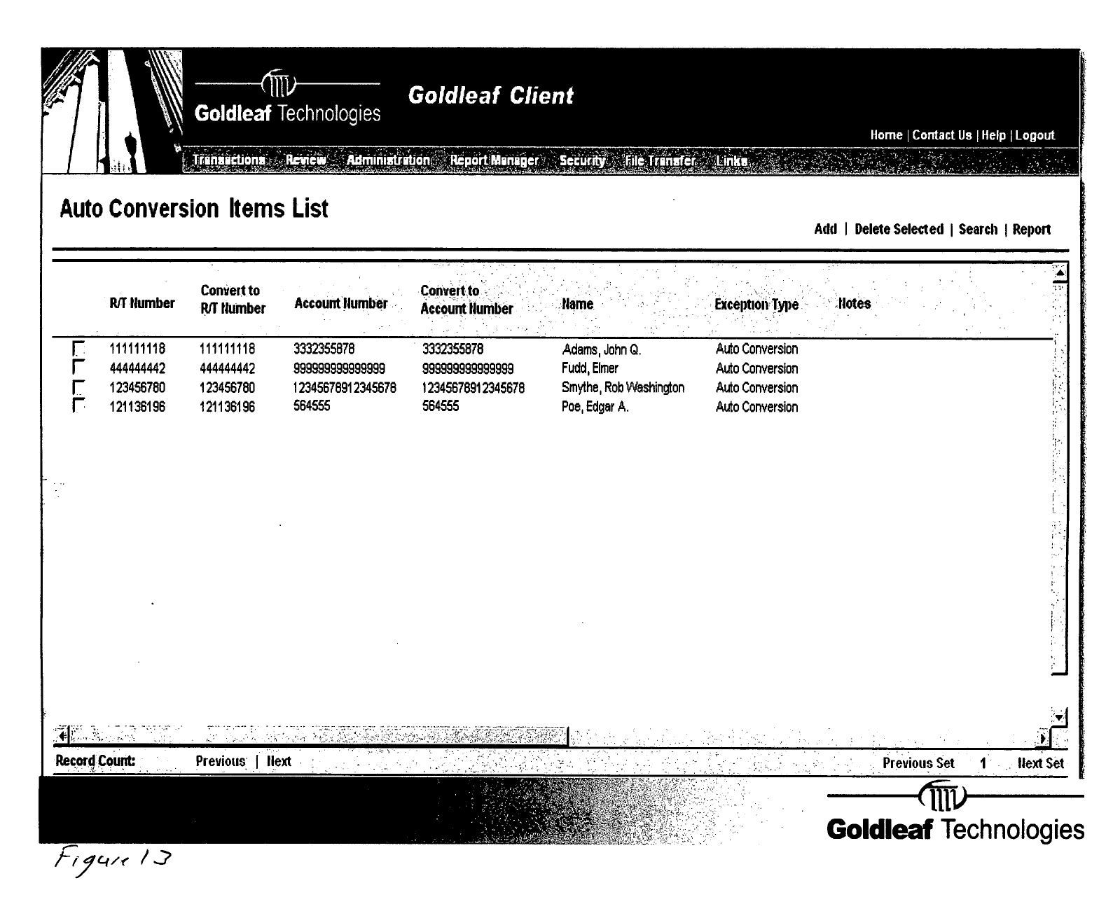

Auto conversion is applicable for ARC, POP, and RCK applications. The original scanned/saved routing number and account number of an auto conversion transaction will be placed in the Notes section of the transaction for later reference. Referring to FIG. 13, an Auto Conversion Items List screen is seen. Add, Delete Selected, Search, and Report functional keys can be provided. The Auto Conversion Items Lists screen includes as columns R/T Number, Convert to R/T Number (optional), Account Number, Convert to Account Number (optional), Name (optional), Exception Type, and Notes (optional). The Exception Type field is read only and is automatically populated as a result of an exception item being added to the Auto Conversion Add/Edit screen as seen in FIG. 13. Selecting Add takes the user to the exception item creation Add screen. Selecting “Delete Selected” removes the exception item(s) that were checked from the list. Selecting Search takes the user to the exception item search page. The search page contains all columns from this page. Selecting Report creates an Opt-Out and Ineligible Items List report and sends it to the Report Manager.

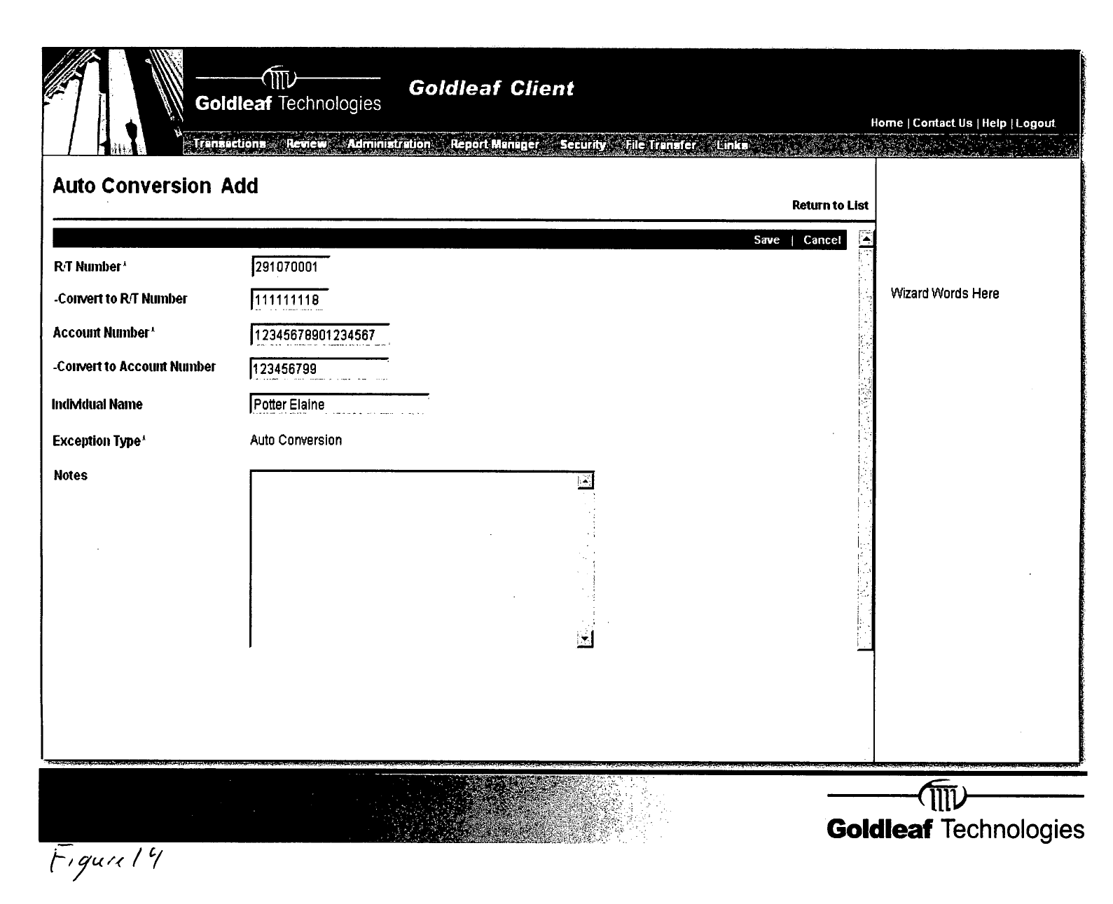

Referring to FIG. 14, an Auto Conversion Add/Edit screen is seen. The Auto Conversion Add/Edit screen includes as fields R/T Number, Convert to R/T Number (optional), Account Number, Convert to Account Number (optional), Name (optional), Exception Type, and Notes (optional). If the R/T Number and Account Number from the scanned check or edited/saved transaction both match the Convert to R/T Number record, and if the Convert to R/T Number field has a value, the R/T Number will be converted to the value in this field. R/T can be converted, Account Number can be converted, or both can be converted based upon the field values. The Exception Type field displays on the Auto Conversion Add/Edit screen and also populates the record of the Exception Type column on the Auto Conversion Items List screen

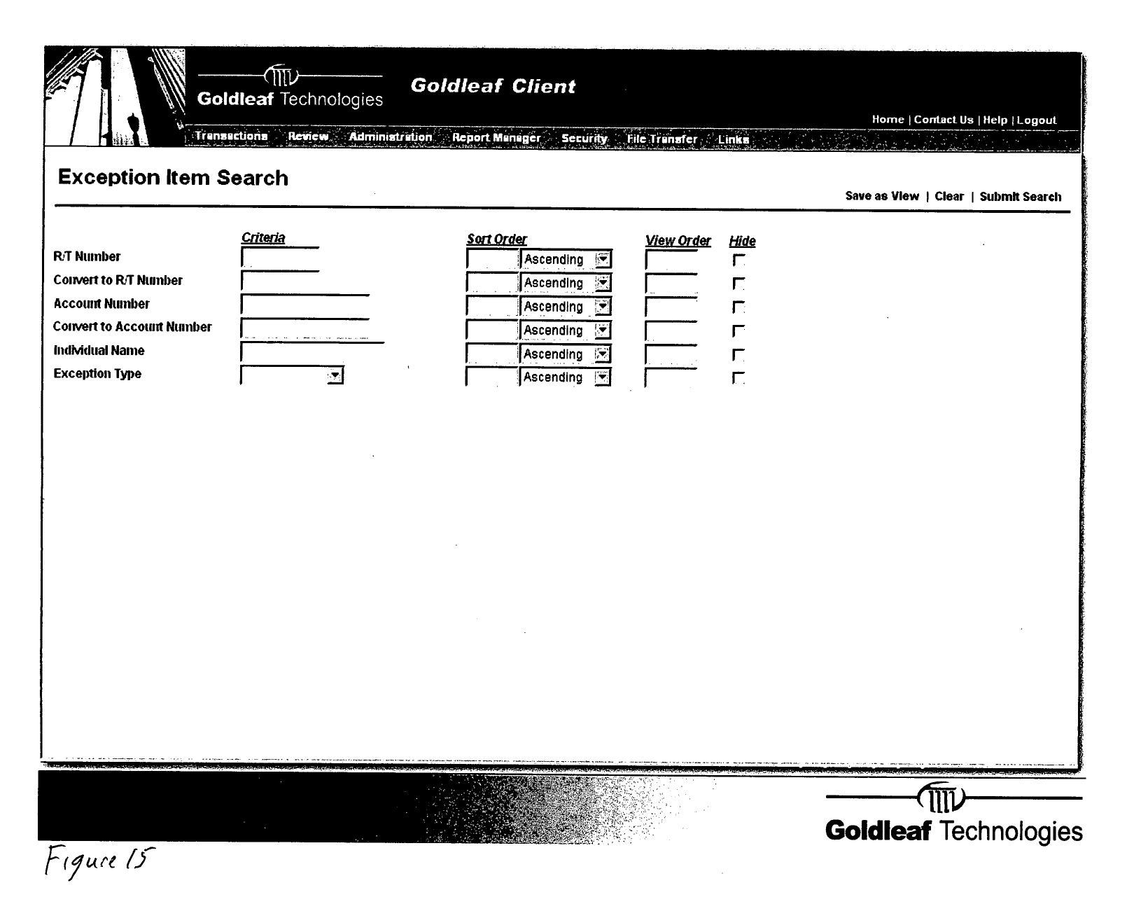

Referring to FIG. 15, an Exception Item Search screen is seen. Save as View, Clear, and Submit Search function keys can be provided. The Exception Item Search screen includes as columns Criteria, Sort Order, View Order, and Hide; the Exception Item Search screen includes as rows R/T Number, Convert to R/T Number (optional search field), Account Number (optional search field), Convert to Account Number (optional search field), Individual Name (optional search field), and Exception Type (optional search field). Exception Type is a drop-down menu with four values: ARC Opt-Out, Ineligible, ARC Opt-Out or Ineligible, or Auto Conversion, with a default of blank. A database search can be performed for ARC Opt-Out and/or Ineligible, and a database search can be performed for Auto Conversion, but a search cannot be performed between ARC Opt-Out and/or Ineligible and Auto Conversion.

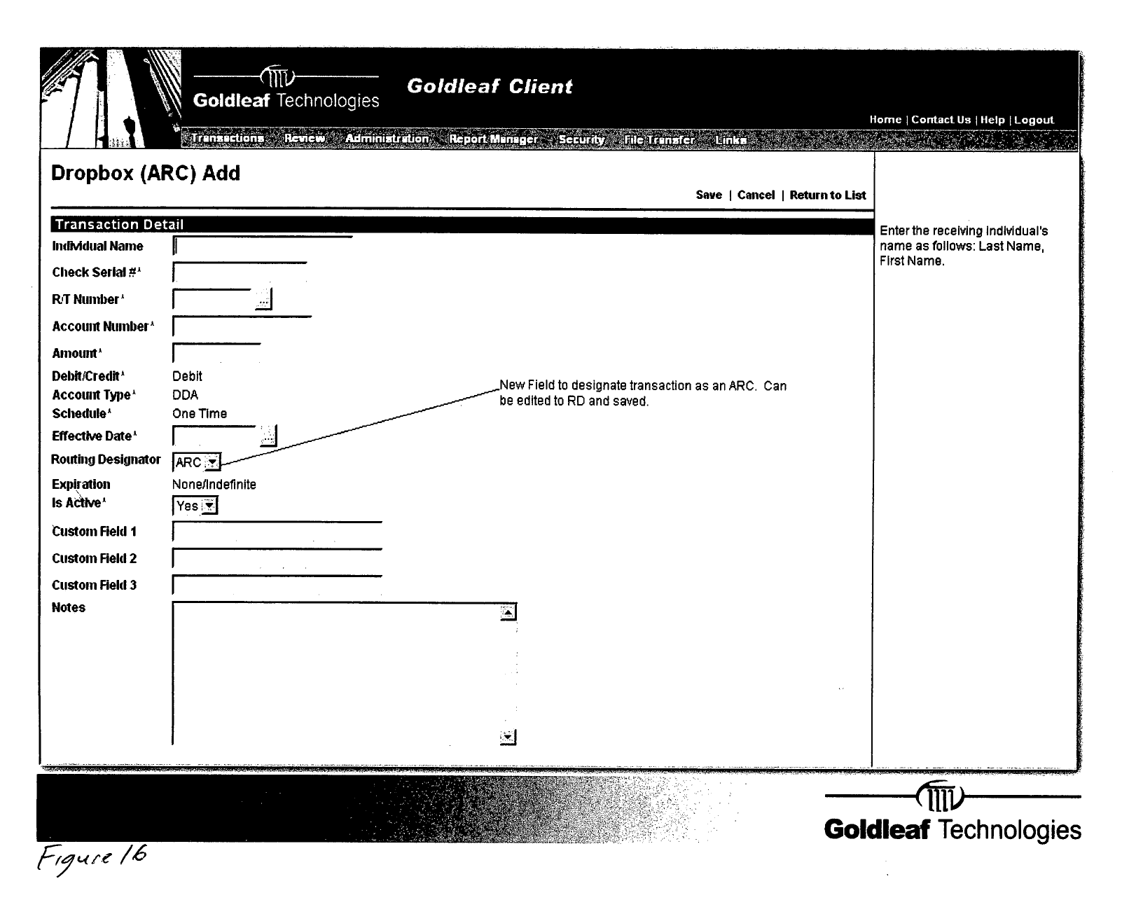

Referring to FIG. 16, an Accounts Receivable Conversion (ARC) Transaction Add/Edit screen is seen. Save, Cancel, and Return to List function keys can be provided. The Accounts Receivable Conversion (ARC) Transaction Add/Edit screen includes as fields Individual name, Check Serial #, R/T Number, Account Number, Amount, Credit Type, Account type, Schedule, Effective Date, Routing Designator, Expiration, Is Active, Custom Fields, and Notes. The Routing Designator is a drop-down menu with ARC or Remote Deposit options. The user can reclassify the routing designation for a transaction, i.e., change ARC to Remote Deposit or vice versa by “editing” in the SmartScan Add or Edit screen, which displays as a drop down box with the existing designator as the displayed value. Value is ARC when it has been designated at scan as ARC eligible. Routing Designator can be edited, and if it passes system edits for the new designator when saved, the transaction is saved. The original scanned/saved routing number and account number of an auto conversion transaction will be placed in the Notes section of the transaction for later reference.

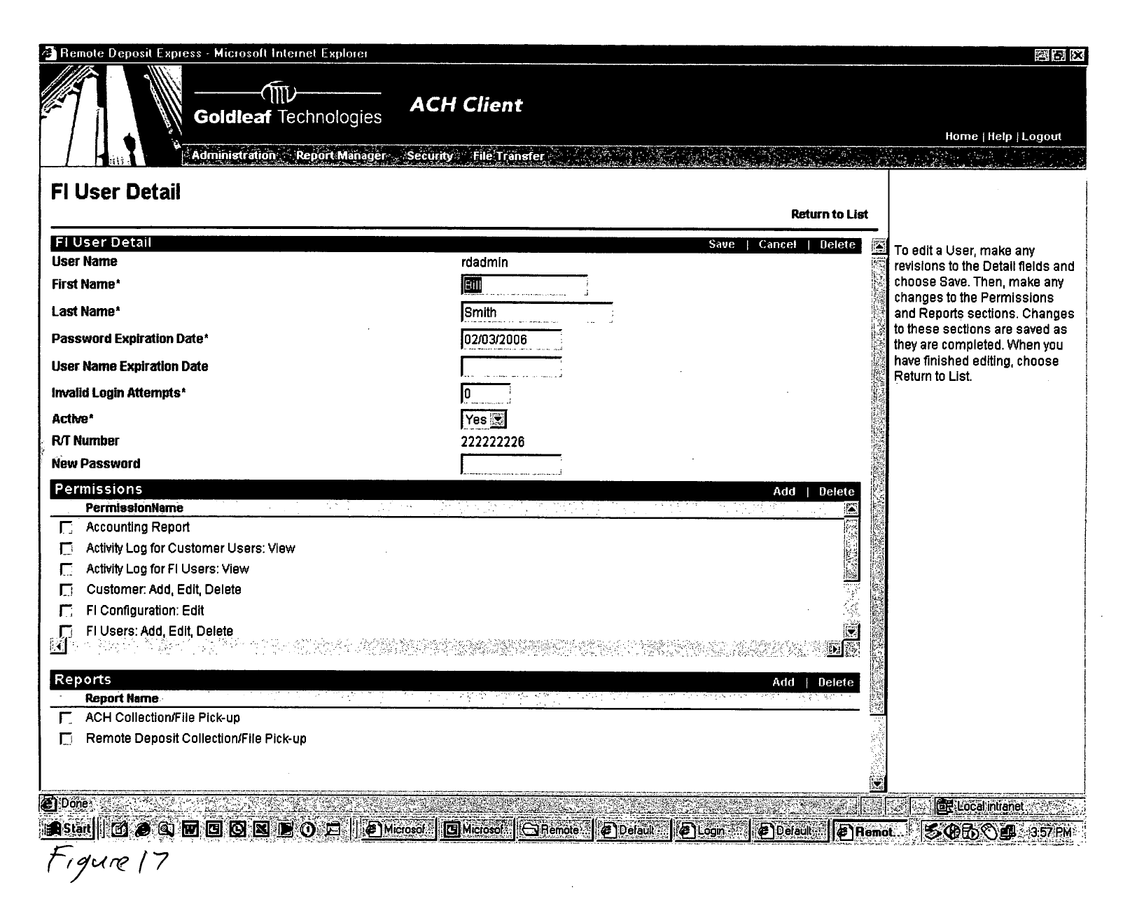

Next, a financial institution user is setup. Referring to FIG. 17, a Financial Institution User Detail screen is seen. A financial institution permissions file can be created. Separate File Transfer Permissions are created covering aspects of application usage. The application pages are dynamically built showing the user functionality for which they have been granted permissions. The Financial Institution User Detail screen can include a Financial Institution User Detail section can have as fields User Name, First Name, Last Name, Password Expiration Date, User Name Expiration Date, Invalid Login Attempts, Active, R/T Number, and New Password. The Financial Institution User Detail screen can further include a Permissions section having as fields Accounting Report, Activity Log for Customer Users: View, Activity Log for FI Users: View, Customer: Add, Edit, Delete, FI Configuration: Edit, and FI Users: Add, Edit, Delete. The Financial Institution User Detail screen can further include a Reports section having an ACH Collection/File Pick-up and Remote Deposit Collection File Pick-up options. An additional embodiment will allow permission as to whether the financial institution user can perform “Check Repair.”

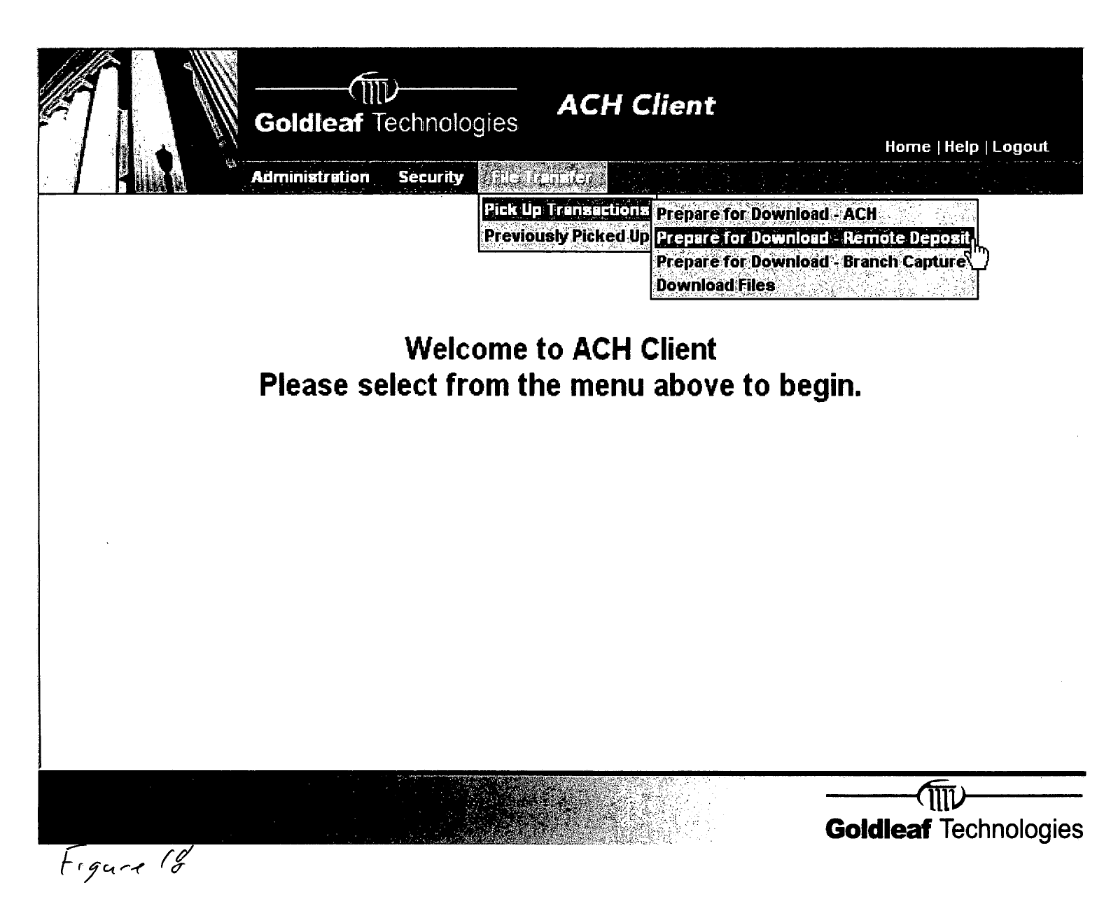

Next, a customer user is setup. A customer permissions file can be created. Separate File Transfer Permissions are created covering all aspects of application usage. The application pages are dynamically built only showing the user functionality for which they have been granted permissions. Referring to FIG. 18, a Financial Institution Administration Menu home page is seen. The Financial Institution Administration Menu home page can include Administration, Security, and File Transfer drop-down menus. To enable the additional aspect of the present invention in which a check is processed in either a Remote Deposit mode or in an accounts receivable conversion mode, Administration is selected from the main menu. From the Administration drop down menu, FI Configuration is selected. The following ACH specific sections are completed by entering appropriate information: Maximum Look Ahead Days for Credits and Maximum Look Ahead Days for Debits. Look Ahead days will be applicable only to ARC transactions; Remote Deposit transactions will ignore the Look Ahead Days logic. In addition, stale dates checking will be applicable only to ARC transactions; Remote Deposit transactions will ignore Stale Date checking.

The following Remote Deposit specific sections are completed by selecting or entering appropriate information: Remote Deposit Configuration, Remote Deposit Contact Information, and Deposit Slip Definition (if a virtual deposit slip is to be created). Again from the Administration drop down menu, Remote Deposit Definition is selected. Add on the Remote Deposit Definition List is selected to add the additional aspect of the present invention in which a check is processed in either a Remote Deposit mode or in an accounts receivable conversion mode. Requested information on the Remote Deposit Definition Add screen is completed by selecting or entering appropriate information: select Yes on the option “This is a SmartScan Category” to enable the additional aspect of the present invention in which a check is processed in either a Remote Deposit mode or in an accounts receivable conversion mode, the default value is No, and, if edited to No, this category reverts to a normal Remote Deposit Category. The SmartScan Category has been enabled and configured, including Remote Deposit and ACH-ARC.

The File Transfer drop-down menu can include Pick Up Transitions and Previously Picked Up links. The Pick Up Transactions links to Prepare for Download—Remote Deposit, Prepare for Download—Branch Capture, and Download Files links. Selection of the Prepare for Download—Remote Deposit links to a Pick Up Transactions—Remote Deposit screen.

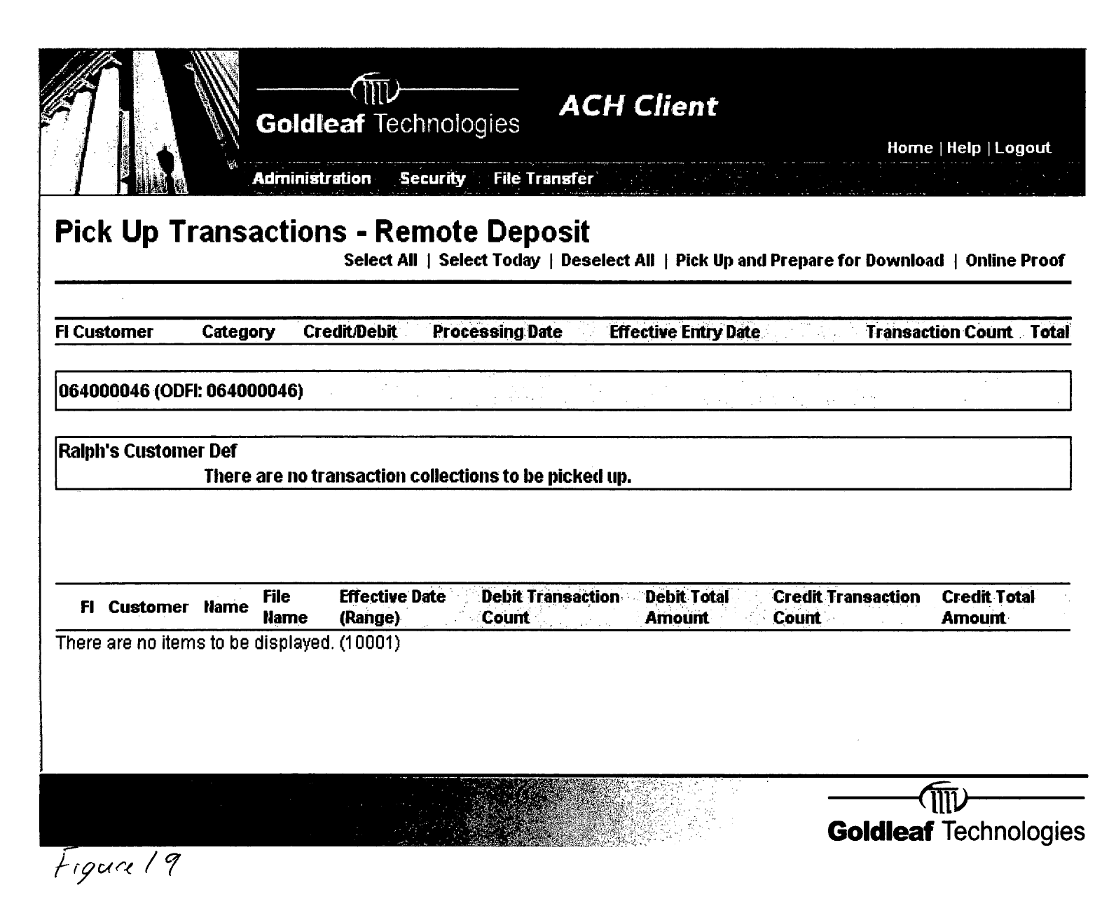

Next, transaction processing by a financial institution is provided. Collections will proceed through Submit, Verify & Authorize stages; but, at the time of authorization, the collection will be stratified and displayed in the Pickup Transactions screen in the appropriate section, i.e., ACH or Remote Deposit. A Collection consisting of either ARC or Remote Deposit transactions can be unauthorized. This is because the collection is separated at authorization. If both ARC and Remote Deposit require un-authorization, both collections must be selected. SmartScan Categories must be Verified/Authorized in total. File Export, which is available only at the verify and authorize stages, will include all data elements in the collection, even though some fields will not be populated with a value. Referring to FIG. 19, the Pickup Transactions screen is seen. The financial institution must select both the ARC and Remote Deposit collections which are listed separately according to the file type. The SmartScan Collections have been separated into ARC and Remote Deposit specific collections at authorization, and the financial institution downloads accordingly. A pickup section for Remote Deposit is displayed only if Remote Deposit Category has been established. If Remote Deposit is enabled for the financial institution and Remote Deposit customers are enabled, a separate Remote Deposit pickup section can be provided: Files can be segregated into Deposit Slips, On-us Files and Foreign Files. The purpose of the Remote Deposit sections is to alert a financial institution that it has Remote Deposit Files that require routing through check processing.

In the additional embodiment that will allow a permission as to whether the financial institution user can perform “Proof”, a financial institution user with “Proof” permission can select Proof from the menu, pick from the list of collections awaiting Proof, and quickly enter check amounts for each transaction as the check image appears.

A financial institution user with Proof permission navigates to the FI Pickup Transactions screen. Items requiring proof are highlighted in blue. The financial institution user selects Proof and collections requiring proof will display. The financial institution user selects the collection(s) to proof, the proof screen is displayed and proof begins.

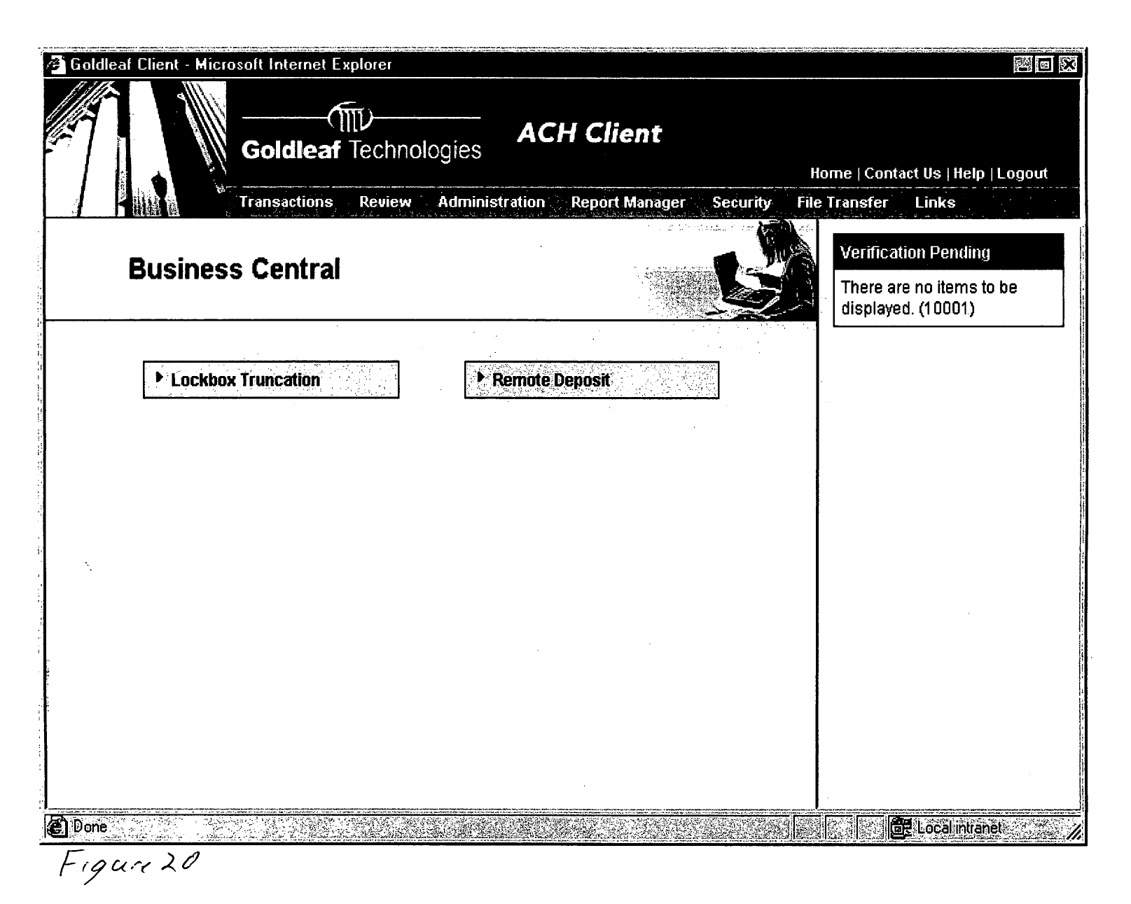

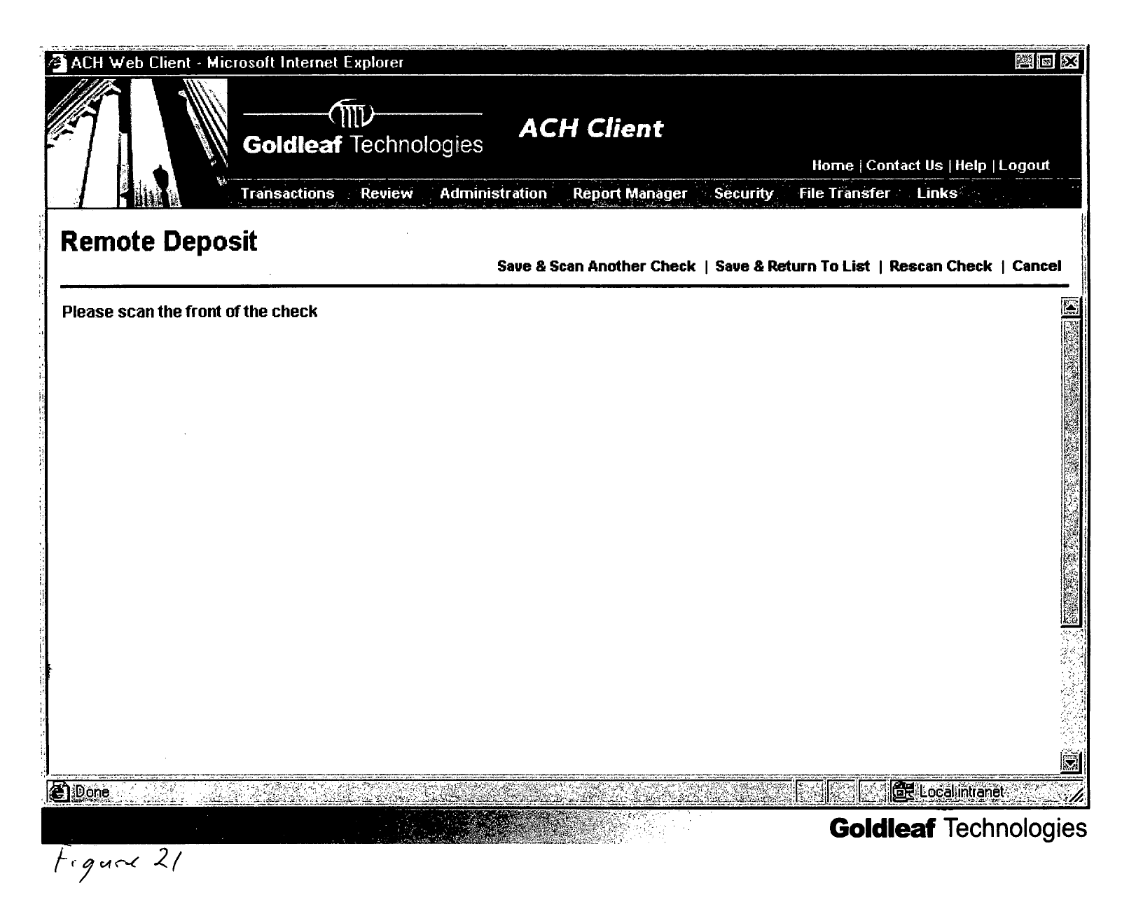

Next, referring to FIGS. 20-23, customer check capture is provided. Remote Deposit Customer Transaction can be created. FIG. 20 shows a screen which acts as the customer home page. The customer can select Remote Deposit. The Remote Deposit instruction screen seen in FIG. 21 instructs the customer to scan the check. The front of a check is scanned. From the Main Menu or main screen Quick Start link, the SmartScan Category is selected. Next, Scan is selected. A check is (or checks are) inserted into the scanner or into a digital check scanner such as those provided by RDM Corporation, 4-607 Weber Street North, Waterloo, Ontario N2V 1K4 Canada. Additional steps, if any depend upon brand and model of scanner used. The check is scanned for front and back image and acquisition of the data on the MICR line. The system identifies transaction for ARC or Remote Deposit routing based on system parameters, with ARC preferred for least cost routing. Checks identified as non-eligible for ARC are automatically classified as Remote Deposit.

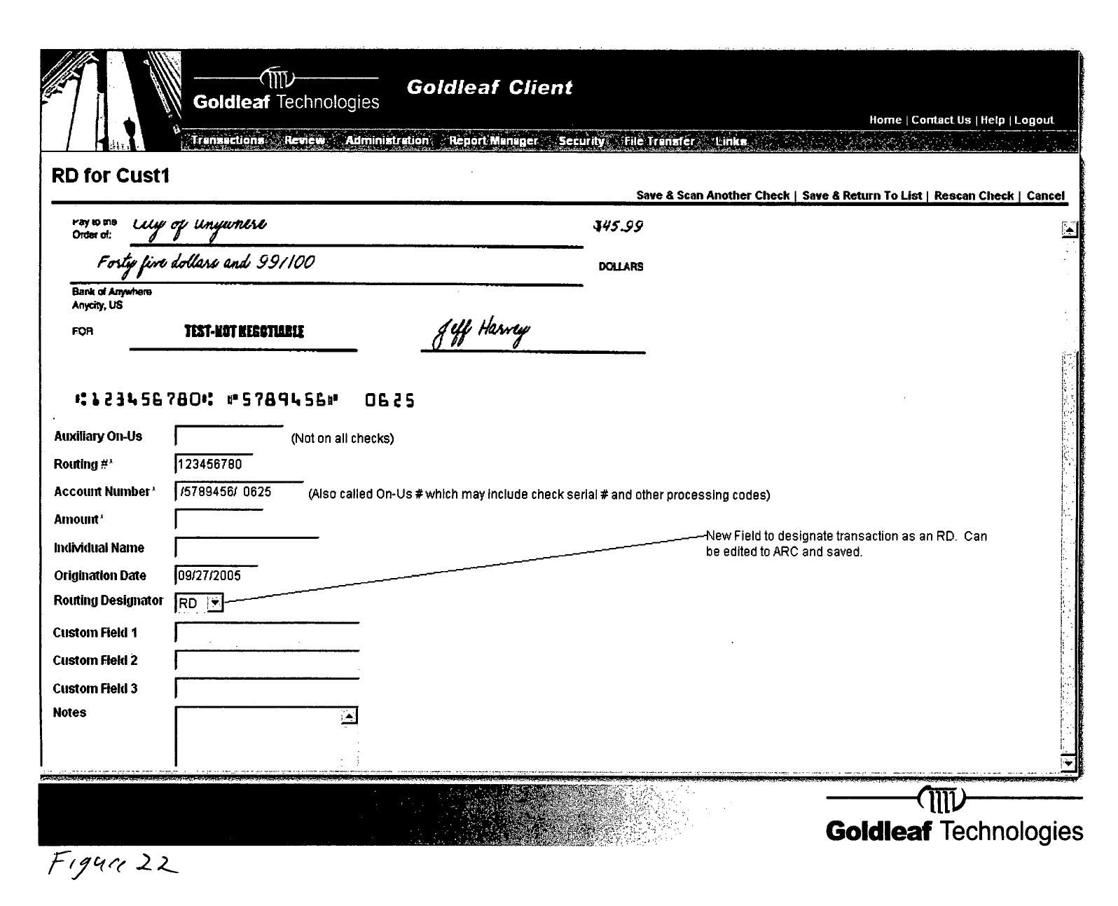

The Remote Deposit Add/Edit screen, seen in FIG. 22, is completed. The scanned check is displayed. ARC and Remote Deposit Add screens are specific to each transaction type; an appropriate ARC or Remote Deposit Add screen is displayed to the user based upon identification as ARC or Remote Deposit (FIG. 22 shows a Remote Deposit Add Screen). Save and Scan Another Check, Save and Return to List, Rescan Check, and Cancel fields are provided. At Save, SmartScan Category transactions share a single Transaction List. ARC and Remote Deposit transactions display their specific transaction information. Fields not valid for a transaction type are displayed as empty values and cannot be edited with any value. ARC or RD (Remote Deposit) is displayed in the Transaction List to identify the transaction type. The Remote Deposit Add/Edit screen includes as fields Auxiliary On-Us (not on all checks), Routing #, Account Number (also called On-Us number which may include check serial number and other processing codes), Amount, Individual name, Origination Date, Routing Designator, Custom Fields, and Notes.

The scanned image is reviewed for quality and the MICR line information for accuracy. Required and any optional transaction fields are completed. The only additional required field is Amount. The name of the individual, which is not a required field, can be an information only field and is not a part of the transaction file. The Routing Designator appears only when the transaction is associated with a SmartScan Category. The Routing Designator is a drop-down menu with ARC or RD. Value is Remote Deposit when it has been designated at scan as non-ARC eligible thereby routed as Remote Deposit. Routing Designator can be edited, and if it passes system edits for the new designator when saved, the transaction is saved. Debit/Credit, which is not applicable, does not display on an entry screen. Account Type, which is not applicable, does not display on an entry screen. Effective Date is replaced by Origination Date, which can be system generated and added to the transaction field at save. There is no stale date test in Submission, and there are no Look Ahead Days. Any active transaction in the list is eligible to Submit (any scan date can be submitted, verified and authorized). Schedule is not applicable. Expiration is not applicable. Is Active can default to “Yes”. Is Active changes to “No” after transaction is authorized the same as any other one-time transaction. Custom Fields 1, 2, and 3, and notes fields are available as information fields only, and are not a part of the transaction file. The original scanned/saved routing number and account number of an auto conversion transaction can be placed in the Notes section of the transaction for later reference. Image Quality Engine can be initiated at item scan, and provides data to populate a specifically defined record within the X9.37 file that alerts all entities that will process the check image as to the status of the image quality for the transaction. Save Transaction and Return To List is selected, or Save Transaction and Scan Another Check.

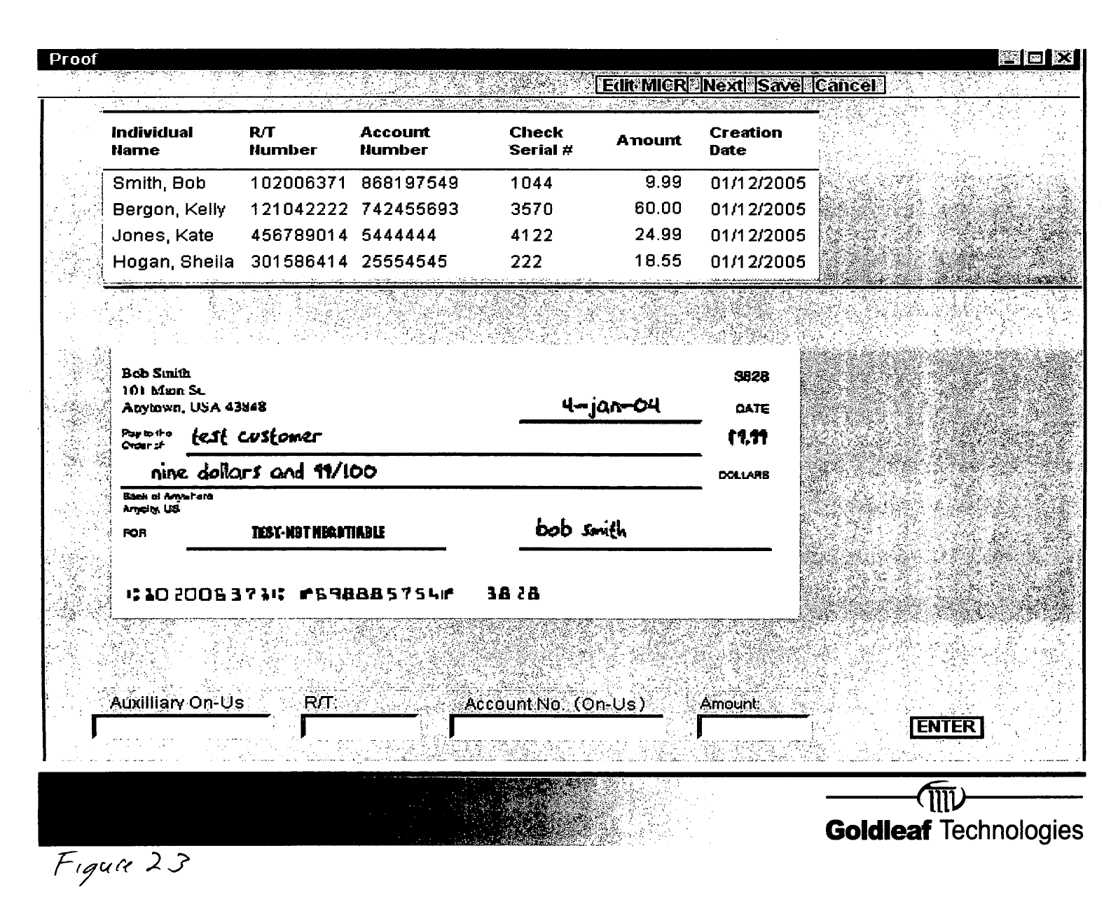

Referring to FIG. 23, a Proof screen is seen. The Proof screen displays the current “set” of transactions, with the first transaction's check visible in the image display. The current “set” of transactions is displayed in a section with Individual Name, RUT Number, Account Number, Check Serial #, Amount, and Creation Date columns. Function keys include Enter (accept entered data and display the next transaction/image), Up Arrow/Down Arrow (move to previous or next transaction/image), and Page Up/Page Down (Move to previous or next “set” of transactions/images). Menu items include Edit MICR (permits any MICR field to be edited), Next (display next check image (next transaction)), Save (saves transaction and display next transaction), and Cancel (cancels edits and return to Pickup screen). A MICR line can be displayed and all MICR fields (except Amount) are grayed out (cannot be edited) until the menu item “Edit MICR” has been selected. Only the amount field can be edited in the default mode. The Proof screen includes as fields Auxiliary On-Us, R/T, Account No. (On-Us), and Amount.

When the current collection is completed and saved, the next Collection in the selected list begins until all collections have been proofed. The user has the option to cancel the proof process and return to the FI Pickup Transactions screen by selecting Cancel. If the financial institution user wants to approve a collection(s) in the FI Pickup Transactions screen without reviewing the collection and if that collection was created by a customer who has the authority to enter amounts for each transaction, the financial institution user can bypass the review process by selecting the collection(s) to be approved and clicking the Approve Selected menu item. If the financial institution user performs the proof function on a collection that requires (or also requires) manual approval, the financial institution user must select the collection(s) and click Approved Selected in addition to performing the proof function. Proof and Save in this case, does not automatically approve the collection for automated push.

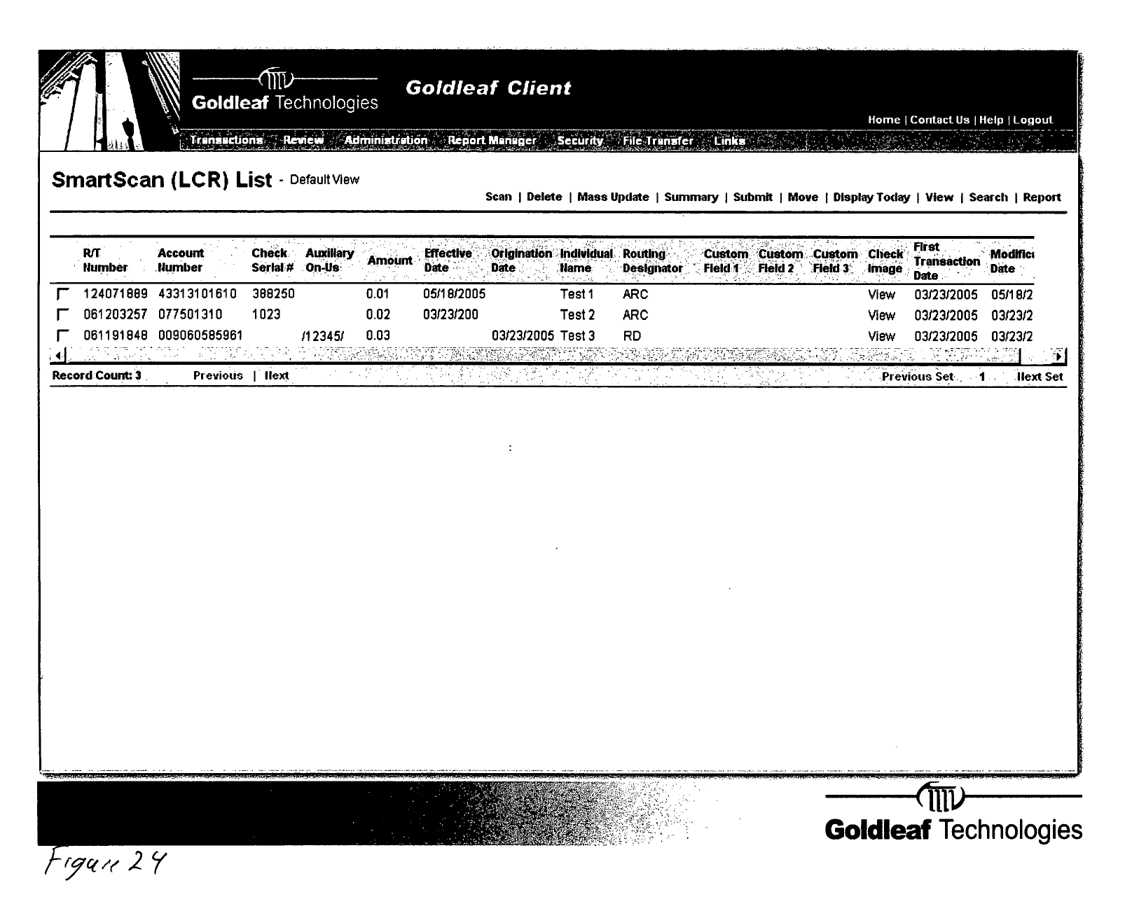

As seen in FIG. 24, the results of the customer check capture are displayed in a Transaction List screen. (Note, not all of the fields described can be seen in FIG. 23). The Transaction List will contain both ARC and Remote Deposit transactions, which each have different data fields and processing characteristics. All ARC and Remote Deposit fields will be displayed, and a transaction will populate the fields appropriate for that transaction type (RD/ARC). The Transaction List Search screen and function will display and utilize all search fields for both ARC and Remote Deposit. The Transaction List screen can contain fields for both ARC and Remote Deposit transaction types, but will be populated only as appropriate for that type as described below.

Scan, Delete, Mass Update, Summary, Submit, Move, Display Today, View, Search, and Report function keys are provided. Mass Update will be specific to the SmartScan Category and will include two options: Active/Inactive and Effective Date. The Transaction List screen includes as columns R/T Number (populated for both ARC and Remote Deposit), Account Number (populated for both ARC and Remote Deposit), Check Serial # (populated only for ARC), Auxiliary On-Us (populated only for Remote Deposit), Amount (populated for both ARC and Remote Deposit), Effective Date (populated only for ARC), Origination Date (populated for only for Remote Deposit), Individual Name (populated for both ARC and Remote Deposit), Routing Designator (populated for both ARC and Remote Deposit), Is Active (populated for both ARC and Remote Deposit), Check Image (populated for both ARC and Remote Deposit), Custom Fields (populated for both ARC and Remote Deposit), First Transaction Date (populated for both ARC and Remote Deposit), Previous Transaction Date (populated for both ARC and Remote Deposit), Debit/Credit (populated for only ARC), Account Type (populated for only ARC), Times Sent (populated for both ARC and Remote Deposit), Creation Date (populated for both ARC and Remote Deposit), and Modification Date (populated for both ARC and Remote Deposit). An image that fails the image quality test will receive a rescan check message, and a transaction cannot be created until the image passes. The Transaction Summary screen and all reports will reflect zero ($0.00) amounts. The financial institution has the option to review all collections and set the number of proof images displayed at a time.

For any Remote Deposit customer, regardless of customer's permissions to enter or not enter check amounts, a financial institution user with “proof” permission can select Proof in the menu, pick from the list of Remote Deposit Collections awaiting proof or awaiting pickup, and review/edit check amounts for each transaction as the check image appears. If the “File Push” option (which automatically moves an authorized collection to an financial institution's designated web service) at FI Configuration has been enabled (eliminating the prepare for pickup and download steps), and the financial institution user also wants to retain the option to review collections prior to “push” occurring, an additional option must be enabled in the FI Configuration. If the Review All Collections option is enabled, “push” will not occur until the financial institution manually approves any/all collections. To approve a collection, the financial institution must select the collection(s) and click on the “Approve Selected” button in the menu bar of the FI Pickup screen. Enabling “Review All Collections” negates the automated benefits of the “push” option, i.e., automated push when a customer authorizes a collection will not occur. When proof function is selected by a financial institution user with proof authority, collections requiring proof will display and proof function can occur for the selected collection. A financial institution user with proof authority can individually select and review and/or repair any Remote Deposit collection even if the customer has amount entry authority, unless “push” has been enabled and “Review all Collections Prior to Download” has not been enabled.

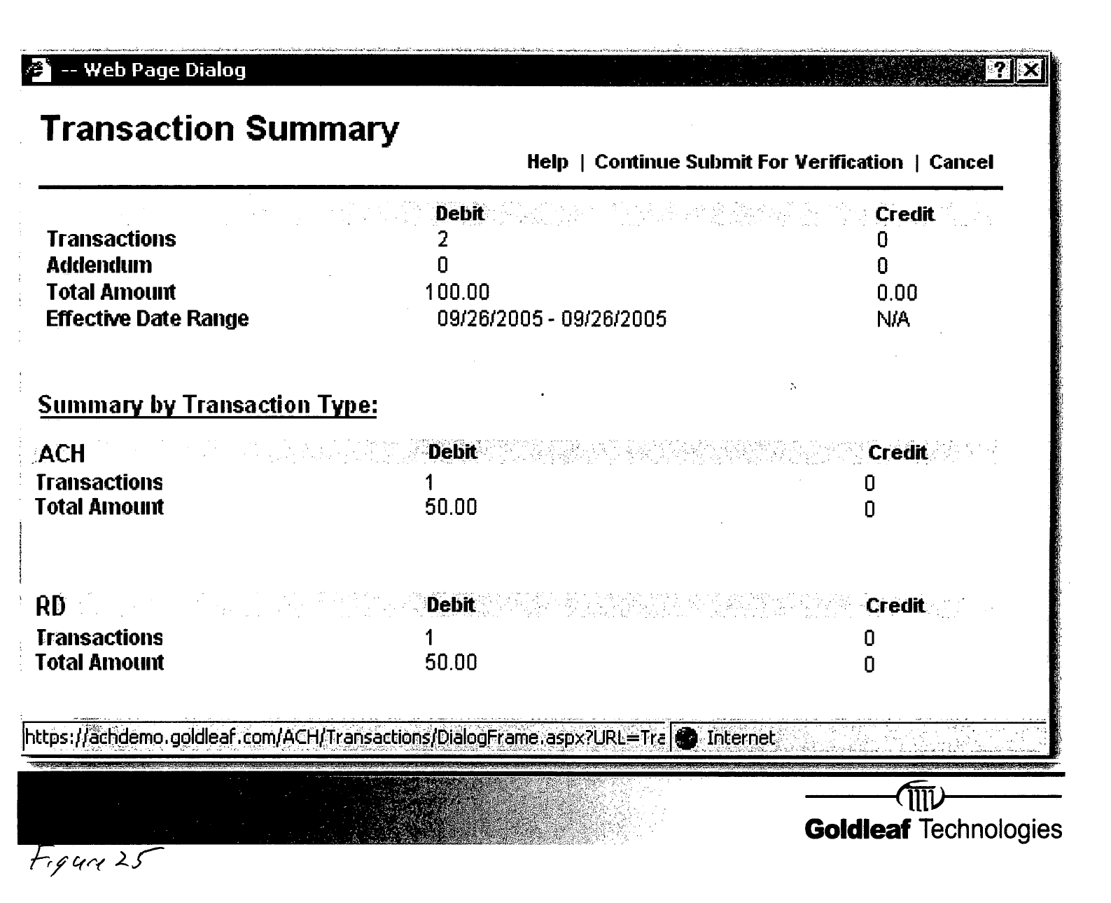

Referring to FIG. 25, a Transactions Summary screen is seen. At the time a collection is authorized, the collection is separated by type and is moved to the appropriate section in the financial institutions Pickup Transactions screen, i.e., ACH or Remote Deposit. Help, Continue Submit for Verification, and Cancel function keys can be provided. The Transactions Summary screen includes an overall summary section, a summary of ACH transaction section, and a summary of Remote Deposit transaction section. All the sections include as columns Debt and Credit. The overall summary includes as rows Transactions, Addendum, Total Amount and Effective Date Range. The summary of ACH transaction and summary of Remote Deposit transaction sections include Transactions and Total Amount. When a collection is picked up by the financial institution, the file created/downloaded follows ARC and X9.37 rules as appropriate

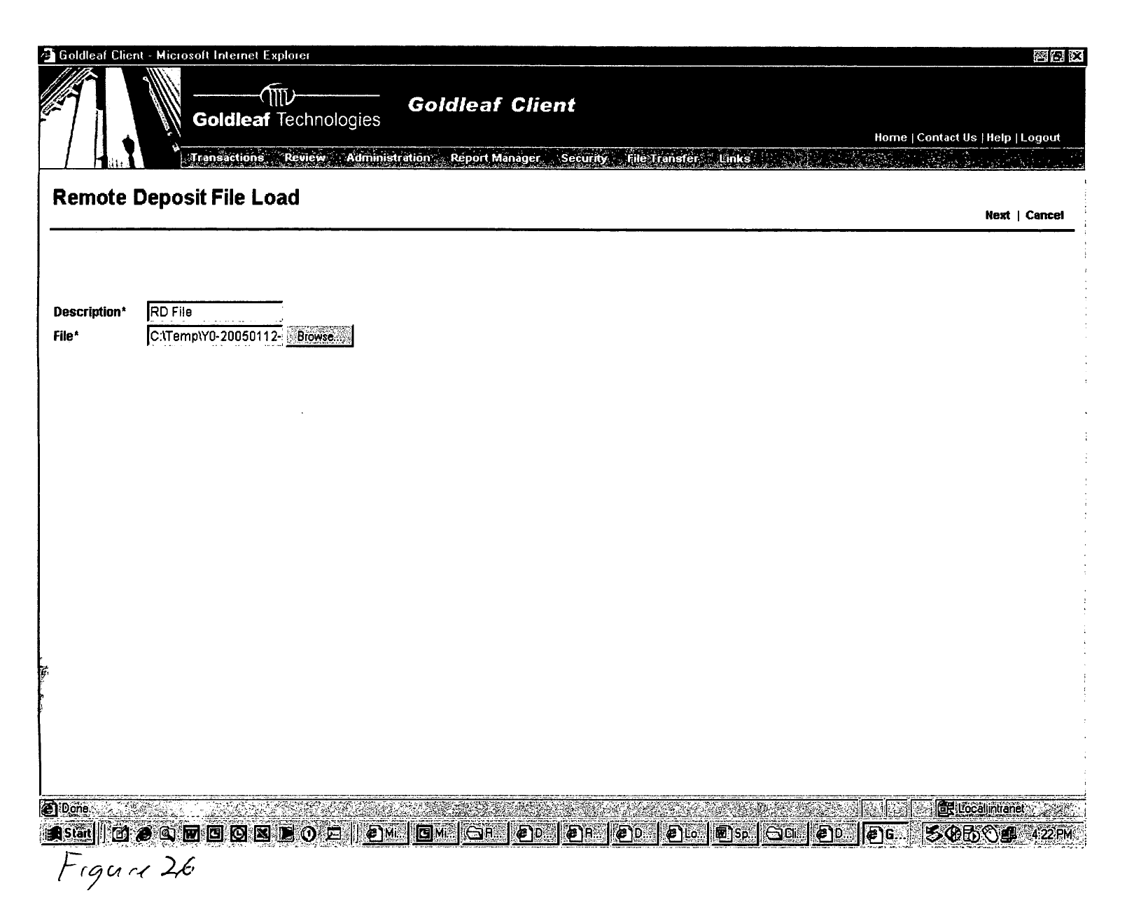

Referring to FIG. 26, a Remote Deposit File Load screen that enables customer file load is seen. At the Main Menu, Load File submenu under File Transfer provides a Remote Deposit File type. The Federal Reserve Bank sets a maximum permitted file size. Any loaded files exceeding the Federal Reserve Bank maximum are rejected, with an error message: File size exceeds Federal Reserve Bank maximum.

If Remote Deposit Validation is set to “No” at the financial institution level, the system will validate only the minimum required fields for 1) Security; 2) Risk; and 3) to permit the system administrator and the financial institution to build the Accounting Report to support billing purposes. Based on a financial institution's Customer Definition setting, 1) the Check 21 formatted file is validated per (X9.37) and an invalid file is rejected; or 2) the Check 21 file is not validated and a Pass Through of an invalid file is permitted only if there is valid data contained in the fields described below. There is no option to pick and choose which of the file structure/values are validated.

The file is either validated according to X9.37 standards or it is not validated. Valid X9.37 file representations are EBCDIC and/or ASCII, but are dependent upon a financial institution's Customer Definition setting of acceptable type. An error can be provided when rejecting a file for bad or incorrect data. The validation is not stopped on first error: the entire file can be validated and a summary can be provided. Fields/location, etc. are identified as necessary to guide customer as to specifics of the error. The system will permit a file to pass through if the financial institution's Remote Deposit Definition is set to “No” for Validate File and the following fields can be identified and validated: File Creation Date; Originator ID; Debit Totals (totals match to file record); Number of Transactions (count matches to file record); Remote Deposit File Load, Remote Deposit File Load Confirm; and Remote Deposit File Load Confirmation.

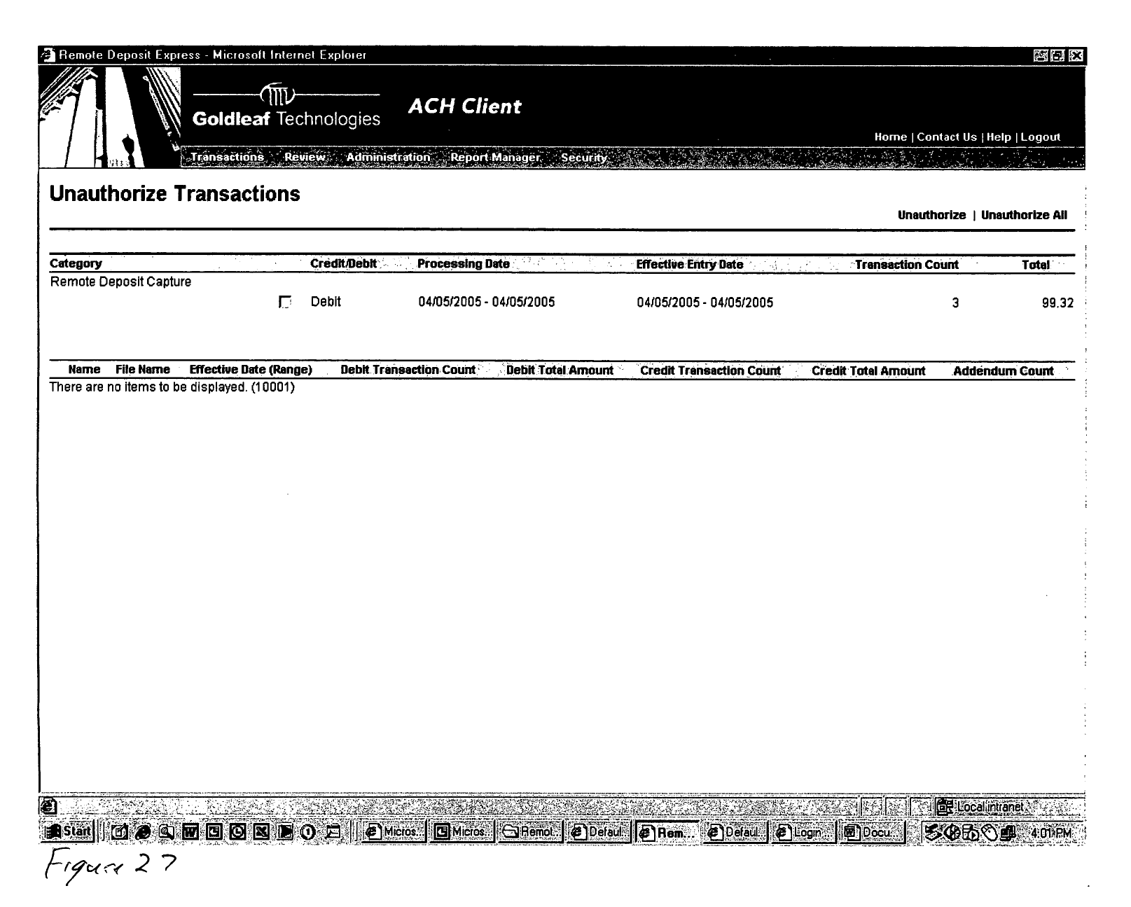

Transaction and File Verification and Authorization include Remote Deposit Category in Verification/Authorization. In Transaction and File Unauthorization, an Unauthorize Transactions screen is seen in FIG. 27. The Unauthorize Transactions screen can be modified to match a financial institution Pickup screen (add Remote Deposit and branch capture collection and pass through sections). The Image Quality Engine is limited to system created transactions, does not perform quality tests on Pass-Through files, and does not populate the specifically defined record within the X9.37 file that alerts all entities that will process the check image as to the status of the image quality. Image quality of a Pass-Through file is the responsibility of the originating software.

The file specifications are in accordance with the American National Standards Institute (ANSI) Draft Standard for Trial Use (DSTU) X9.37-2003 Specifications for Electronic Exchange of Check and Image Data. Acceptable file representations are EBCDIC (required by the Federal Reserve Bank) and ASCII for Pass Through files if enabled by the financial institution. (See Federal Reserve Adoption of DSTU X9.37-2003 Image Cash Letter Customer Documentation, Version 1.1 of Jul. 1, 2004. Federal Reserve Adoption is a clarification for Federal Reserve purposes of the DSTU X9.37-2003 specification.) For Pass Through files only, file validation includes verification that a transaction's image MICR is identical to the transaction record.

System Creation Setup can be administered by a database encrypted default setting script. A Remote Deposit option is provided, with a default of “No”. A financial institution user's Add, Edit, Delete Permission will access the financial institution Definition List. Add is selected for a new financial institution, or any field can be selected in the financial institution's row to edit an existing financial institution.

Remote deposit can be enabled at the Remote Deposit form (the Remote Deposit Add/Edit is seen in FIG. 22; however, the Remote Deposit enable fields are not shown). The Remote Deposit is enabled in the Remote Deposit section, Remote Deposit Origination can be added. Remote Deposit File is added to the section File Types: Pass Through. Acceptable X9.37 file representation, EBCDIC (Federal Reserve Bank standard), ASCII, or both are added.

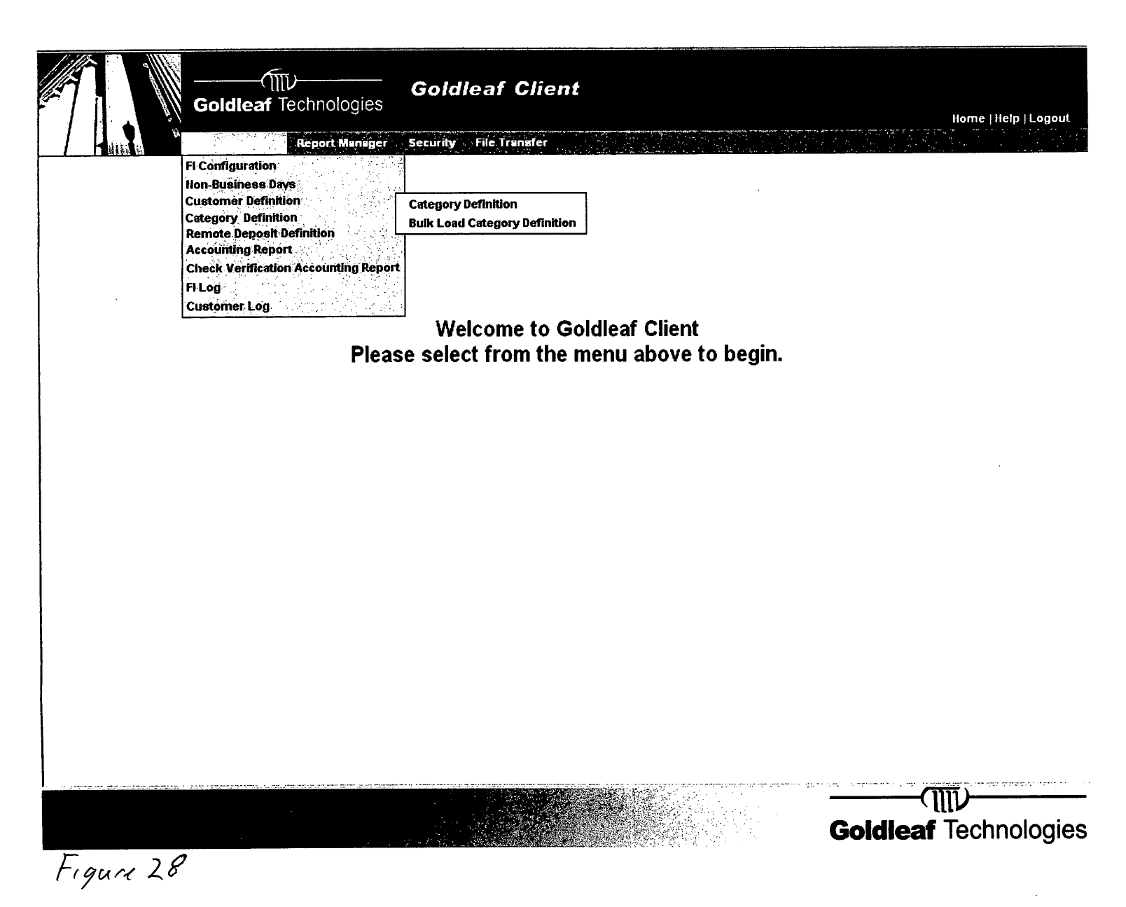

Next, the financial institution Remote Deposit can be setup. At the Home Page, a financial institution user with Customer Add, Edit, and Delete Permission will select Administration from the Main Menu. Referring to FIG. 28, the Financial Institution Administration Menu home page screen is again seen. The Administration drop-down menu can include as fields FI Configuration, Non-Business Days, Customer Definition, Category Definition, Remote Deposit Definition, Accounting Report, Check Verification Accounting Report, FI Log, and Customer Log. Customer Definition can be selected. At the Customer Definition List, Add can be selected for a new customer, or any field in the customer's row can be selected to edit an existing customer. RDM Owner Code is entered for any Remote Deposit and/or branch capture customer, as it is required to scan checks.

Remote deposit can be enabled at a Customer Definition Add/Edit screen as follows: In Remote Deposit and/or branch capture section, Remote Deposit Origination can be added; Remote Deposit File can be added to the section File Types: Pass Through; the acceptable file representations are selected from drop down menu (the options are EBCDIC and ASCII); and the setup information or edit field(s) are saved. From the Main Menu, Remote Deposit Definition can be selected. Referring back to FIG. 7, Customer Definition Edit screen, Add can be selected or, to edit an existing Remote Deposit setup, Remote Deposit can be selected. Referring to FIG. 8, the Remote Deposit Definition Edit screen is seen. If a new Remote Deposit is being added, the applicable Definition screen will appear. If Remote Deposit is being edited, the applicable Definition screen will appear when it is selected.

Next, the customer is selected from the Dropdown List. The Originator ID (needed for internal processing and control) is entered. Remote deposit is entered. An option to Require Verification can be provided from a dropdown list, with a default of “Yes”. Selecting “No” permits a submitted or loaded file to bypass Verify and Authorize steps if the user has been established with sufficient authority (verify and dollar limitation checks, etc.). An option to allow Check Scanning can be provided, with a default of “Yes” (which does not appear on this screen). Permitted Account Types and Addenda Exclusions are not applicable to Remote Deposit and do not appear on the screen. When completed, save is selected and the user returns to the Remote Deposit Definition List.

Referring back to the Home screen which acts as the customer home page in FIG. 20, for Customer Setup, at the customer home page, a customer user with Remote Deposit Configuration with Edit permission can select Administration from the Main Menu. For customer security, at the Main Menu (seen in FIGS. 18) customer users are selected. At a Customer Users List screen, Add can be selected for a new user or an existing user can be selected to edit. Remote Deposit Configuration can be added and the user's permissions can be edited. Remote Deposit Authority can be added to the user's authorities. Remote Deposit File can be added to the user's File Load Type Authorities. When finished, save is selected and the user returns to the Customer Users List screen.

To create and process transactions, a financial institution with Remote Deposit File Transfer Authority will see the Remote Deposit collections and files. Otherwise, Remote Deposit items will not be displayed to this financial institution user. From the Main Menu, File Transfer can be selected. From a dropdown menu, Pick Up Transactions can be selected. From a submenu, Prepare For Download can be selected. Remote Deposit Collection section can be scrolled to if picking up system created files. The collection(s) to be downloaded are marked (or Select All can be chosen from the screen menu to pick up all collections and files). Pick Up and Prepare for Download can be selected. Remote Deposit File section can be scrolled to if picking up loaded (Pass Through) files. The file(s) to be downloaded are selected (or choose Select All from the menu to pick up all collections and files). Pick Up and Prepare for Download can be selected. From the Download File screen, the file(s) to be downloaded are marked (or Select All can be chosen from the screen menu). Download can be selected, and the download proceeds using the File Download dialog box.

To create a Customer Transaction, transactions must be scanned into the Transaction List. An image of the front and back of the check is a required component of the X9.37 file format. Although the front and back images are required, the Remote Deposit Configuration will permit the following scan options: Scan Front and Save Image (for use with RDM Archive Service); Scan Front/ Back And Save Image (for use with RDM Archive Service); Scan Front and Do Not Save Image (not currently a valid option as X9.37 format for IRD requires both front and back of image); and Scan Front and Back and Do Not Save Image (saves image as part of X9.37 file only).

From the Remote Deposit Transaction List menu, Scan can be selected. Begin Scanning Checks is selected. The check is inserted in scanner face up when the message appears: “Please scan the front of the check.” The check is inserted in scanner backside up when the message appears: “Please scan the back of the check.” The form is completed when the message appears: “Please complete the form.” Required fields are indicated by an asterisk (*). The only required field not read from the check MICR is amount. In a first embodiment, if the amount field has not been encoded on the item, this amount is manually entered. In a further embodiment, a system in accordance with the principles of the present invention can scan the amount field(s) and automatically enter the amount. All others are optional for internal research assistance, and do not travel with the transaction. There is no effective date field. Effective Date is applicable for ARC only, which will be noted on the screen. Remote Deposit transactions do not have an Effective Date. The effective date is replaced by origination date, and no stale date test occurs. Any scan date can be submitted, verified, and authorized. Save and Scan Another Check or Save and Return To List can be selected. Rescan Check is available for MICR read or image errors.

All checks are eligible for Remote Deposit, including business, government, counter checks, money orders, Cashier's Checks. Check serial number is not a required field for Remote Deposit. Any transaction field can be edited. Extraneous dashes are removed from the MICR data per Federal Reserve Adoption of DSTU X9.37-2003 Image Cash Letter Customer Documentation, Version 1.1 of Jul. 1, 2004.

In one embodiment, image archival option can be available on the RDM archive site (for ARC, POP and RCK). RDM image archival is independent of the Check 21 IRD specifications. Images that are part of the IRD are stored as part of the Check 21 file format, and only until they are no longer available from the Previously Picked Up Transactions and Files screen, which can be a system configurable number of days after the financial institution picks up. If RDM image archival is provided, a check image can be viewed in the Transaction List by selecting View in the transaction's Check Image column.

Any active transaction in the Transaction List is eligible for Submission. Transaction's “Is Active” status can be changed from “Yes” to “No” the same as other one-time transactions. Verification and Authorization process for Remote Deposit can be consistent with other transaction collections and files. Unauthorized transactions/files process for Remote Deposit can be consistent with other transaction collections and files.

Because the system and financial institutions may be pricing Remote Deposit transactions differently than ACH files, a reporting section titled “Remote Deposit” can be included. The “Remote Deposit” reporting section includes system created transactions, and Pass Through files subsections containing same information as with SEC Codes and ACH file Pass Through files. Modifications to all Accounting Reports are required to classify the Remote Deposit Category with available Image Archival options.

While the invention has been described with specific embodiments, other alternatives, modifications and variations will be apparent to those skilled in the art. For example, depending on the particular needs of an investment a financial instrument in accordance with the present investment can be combined with other financial instruments in a single offering. Accordingly, it will be intended to include all such alternatives, modifications and variations set forth within the spirit and scope of the appended claims.

What is claimed is:

1. A system to deposit financial instruments to a financial institution remotely, comprising:
capturing a customer deposit at the place of business of the customer;
converting the Magnetic Ink Character Recognition (MICR) data encoded documents into an image with an associated data file; and
enabling processing in either a remote deposit mode or in an accounts receivable conversion mode.

2. The system of claim 1 further including permitting a customer to automatically convert routing and/or account information when a financial instrument is scanned to facilitate clearing via automatic clearing house.

3. The system of claim 1 further including creating a ghost category for accounts receivable conversion and a ghost category for remote deposit, wherein processing requirements for each is controlled by existing accounts receivable conversion or remote deposit processes.

4. The system of claim 1 further including reclassifying accounts receivable conversion transactions as remote deposit transactions.

5. The system of claim 1 further including reclassifying remote deposit transactions as accounts receivable conversion transactions only if the remote deposit transaction can be validated as eligible for accounts receivable conversion transactions.

6. The system of claim 1 further including converting the image of the financial instrument and related MICR data into American National Standards Institute (ANSI) standard for electronic exchange among financial institutions and processors in a transaction/file.

7. The system of claim 6 further wherein the American National Standards Institute (ANSI) standard for electronic exchange of checks and check data among financial institutions and processors comprises X9.37 format.

8. The system of claim 1 further including the financial institution picking up the transaction/file via an Internet connection.

9. The system of claim 1 further wherein the financial instrument is selected from the group comprising checks, money orders, cashier's checks, deposit slips, general ledger tickets, any non-check item that includes a MICR line, and combinations thereof.

10. The system of claim 1 further including the financial institution picking up the transaction/file via an Internet connection.

11. A system to deposit financial instruments to a financial institution remotely, comprising:
capturing a customer deposit at the place of business of the customer;
converting the Magnetic Ink Character Recognition (MICR) data encoded documents into an image with an associated data file;
permitting the financial institution to restrict the customer's entry of check amounts; and
requiring the financial institution to add check amounts via an online proof option.

12. The system of claim 11 further including converting the image of the financial instrument and related MICR data into American National Standards Institute (ANSI) standard for electronic exchange among financial institutions and processors in a transaction/file.

13. The system of claim 12 further wherein the American National Standards Institute (ANSI) standard for electronic exchange of checks and check data among financial institutions and processors comprises X9.37 format.

14. The system of claim 11 further including the financial institution picking up the transaction/file via an Internet connection.

15. The system of claim 11 further wherein the financial instrument is selected from the group comprising checks, money orders, cashier's checks, deposit slips, general ledger tickets, any non-check item that includes a MICR line, and combinations thereof.
